(19) United States
(12) Patent Application Publication
(10) Pub. No.: US 2026/0183979 A1
(43) Pub. Date: Jul. 2, 2026

(54) HAIR-GUIDING ELEMENT, HAIR-CUTTING ASSEMBLY AND ELECTRIC SHAVER

(71) Applicant: Braun GmbH, Kronberg (DE)

(72) Inventors: Renata Burghardt, Kronberg (DE); Roman Roeder, Usingen (DE); Simone Langwasser, Bad Homburg (DE)

(21) Appl. No.: 19/426,297

(22) Filed: Dec. 19, 2025

(30) Foreign Application Priority Data
Dec. 30, 2024 (EP) 24223668.5

(51) Int. Cl. B26B 19/38; B26B 19/06

(52) U.S. Cl. CPC B26B 19/3846; B26B 19/06

(57) ABSTRACT

Provided is a hair-guiding element for an electric shaver. The hair-guiding element has a skin-contacting surface for contacting skin, and a cutting element-facing surface for facing a cutting element, with the cutting element-facing surface facing in an opposite direction with respect to a direction faced by the skin-contacting surface. The hair-guiding element's periphery provides the hair-guiding element with a toothed profile comprising teeth arranged along a main axis of the hair-guiding element, with the teeth each comprising part of the skin-contacting surface and part of the cutting element-facing surface.

### FIELD OF THE INVENTION

The present disclosure relates to a hair-guiding element for an electric shaver, a hair-cutting assembly comprising the hair-guiding element and a cutting element, an electric shaver comprising the hair-guiding element or the hair-cutting assembly.

### BACKGROUND OF THE INVENTION

Hair-cutting and hair-guiding components of electric shavers, for example electric dry shavers, can be produced in various ways. In general, a hair-cutting assembly of an electric shaver includes two cutting elements: a stationary blade, such as a comb or foil, which has a surface for contacting the skin and is designed to guide/feed incoming hair, and a moving blade, which is normally underneath the stationary blade. The moving blade does not contact the skin, but receives hair fed thereto via the stationary blade and moves in a reciprocating manner to cut the hair. The blades of the hair-cutting assembly can function as a scissor system to cut the hair.

Both cutting elements can fulfil their respective functions by having a certain two-dimensional geometry, when the respective element is viewed in plan, and a cutting edge whose geometry is designed to achieve effective cutting of hair. Such geometries can be produced via photochemical machining, also known as etching, which is a wet-chemical procedure which does not make use of an electrical current. Another possible procedure is precision (or pulsed) electrochemical machining (PECM), where the cutting element normally serves as an anode, and where material is removed through an electrochemical process. Cutting elements can also be produced via mechanical methods, such as stamping, welding, bending, etc.

It would be desirable to provide hair-cutting and/or hair-guiding component(s) for an electric shaver having enhanced geometry, as well as methods for manufacturing such improved hair-cutting and/or hair-guiding component(s). It would also be desirable to provide an enhanced etching method, which etching method could be used for manufacturing the hair-cutting and/or hair-guiding component(s), as well as other types of articles.

### SUMMARY OF THE INVENTION

According to a first aspect of the present disclosure, there is provided a hair-guiding element for an electric shaver, the hair-guiding element comprising: a skin-contacting surface for contacting skin; a cutting element-facing surface for facing a cutting element, wherein the cutting element-facing surface faces in an opposite direction with respect to a direction faced by the skin-contacting surface; a hair-guiding surface on which hair from the skin is receivable, so as to be guided on the hair-guiding surface, when the skin-contacting surface is in contact with the skin; and a periphery that provides the hair-guiding element with a toothed profile comprising teeth arranged along a main axis of the hair-guiding element, with the teeth each comprising part of the skin-contacting surface and part of the cutting element-facing surface, wherein at least some of the teeth each comprise a part of the hair-guiding surface and a tip region that is arranged to receive the hair thereon when the hair-guiding element is moved over the skin, with the part of the hair-guiding surface extending, in a direction transverse to the main axis, away from the tip region and towards the part of the cutting element-facing surface so as to enable the part of the hair-guiding surface to guide the hair that has been received on the tip region towards the part of the cutting element-facing surface, and wherein a tooth thickness at the tip region is less than 250 μm, which tooth thickness is a diameter of a smallest notional circle whose circumference is intersected by both the part of the hair-guiding surface and the part of the skin-contacting surface, with the smallest notional circle's plane being perpendicular to the main axis.

Optionally, the smallest notional circle does not extend outside the tooth. The tooth thickness may thereby be measured less than 125 μm from an extremity of the tip region in the direction transverse to the main axis (125 μm being the maximal radius of a circle having a diameter of 250 μm).

When the hair-guiding element is moved over the skin, with the skin-contacting surface contacting the skin, hair may ride up onto the tip region and glide along the part of the hair-guiding surface towards the part of the cutting element-facing surface.

Users of conventional electric shavers can find that hair can remain uncut despite a comb of the electric shaver being moved over the skin at the location where such hair is present. This can lead to the user moving the comb over the skin at the same location multiple times, which can cause skin irritation.

It has been found that one reason for hair remaining uncut is the angle of hair relative to the surface of the skin, and in particular a relatively small angle relative to the surface of the skin. For example, hair on the neck can protrude from the skin surface at an angle of only around 10°.

By the tooth thickness at the tip region being less than 250 μm, preferably less than 200 μm, it has been found that more hair can be successfully cut in fewer passes of the hair-guiding element across the skin, resulting in less skin irritation.

This is because a tooth whose thickness at the tip region being less than 250 μm can enter a gap of around 260 μm between an end of a hair and the surface of the skin when the hair protrudes from the surface of the skin at an angle of about 10 ° and the hair is about 1.5 mm in length, which corresponds to an upper limit of facial hair growth in 3 days (0.5 mm per day).

It is noted that the skin-contacting surface may have a single plane, with the circumference, of the smallest notional circle whose diameter defines the tooth thickness, being intersected by the single plane of the skin-contacting surface.

The term “transverse to the main axis” may mean perpendicular or at least substantially perpendicular to the main axis when the hair-guiding element is viewed in plan so that the skin-contacting surface or the cutting element-facing surface is facing the viewer.

The qualifier “substantially” may refer to a deviation from perpendicular of up to 10°.

In some embodiments, the part of the hair-guiding surface of the at least some of the teeth comprises a sloping surface that declines, as the sloping surface extends transverse to the main axis, from the tip region towards the part of the cutting element-facing surface, with the sloping surface becoming further from the skin-contacting surface as the sloping surface declines towards the part of the cutting element-facing surface. Thus, the hair received on the tip can glide down the sloping surface towards the cutting element-facing surface.

Separating hair from the skin in this manner can assist to appropriately orientate the hair for cutting as the hair glides down the sloping surface towards the cutting element-facing surface.

In some embodiments, a step is defined between a lowermost region of the declining sloping surface and the part of the cutting element-facing surface, wherein the step provides a height difference between the part of the cutting element-facing surface and the lowermost region of no more than 50 μm. In such embodiments, hair may glide down the sloping surface until the hair reaches the step, at which point the gliding movement of the hair may be terminated, but with the hair being able to surmount the step, e.g. by being bumped or rolling over onto the part of the cutting element-facing surface from the lowermost region of the sloping surface.

By limiting the height difference to no more than 50 μm, an average hair that has glided down the sloping surface to reach the lowermost region can relatively easily surmount the step. This is because the height difference does not exceed half of an average value of the diameter of a facial hair, in other words 50 μm.

The sloping surface may have a gradient defined by a lateral extent of the sloping surface being greater than a height of the sloping surface, with the lateral extent extending, parallel with the skin-contacting surface, from the tip region to a first point aligned with the lowermost region of the sloping surface at a base of the step, and with the height extending, normal to the skin-contacting surface, from the tip region to a second point aligned with the lowermost region.

By the lateral extent being greater than the height, the sloping surface declines relatively gradually from the tip region to the lowermost region of the sloping surface, for example compared to a scenario in which the lateral extent is the same as or is smaller than the height.

Such a relatively gradually declining sloping surface can assist gliding of hair thereon towards the cutting element-facing surface.

In some embodiments, the lateral extent is at least two times greater than the height. Alternatively or additionally, the lateral extent may be at least 200 μm while the height is 100 μm or less.

In some embodiments, a lowermost region of the sloping surface is where the sloping surface reaches, in a stepless manner, the cutting element-facing surface. Thus, hair can continuously glide down the sloping surface to reach the cutting element-facing surface. This can facilitate guiding the hair to the cutting element-facing surface, particularly relative to embodiments in which the hair is required to surmount the step defined between the part of the cutting element-facing surface and the lowermost region of the sloping surface.

In such embodiments, the sloping surface may, for example, have a gradient defined by a lateral extent of the sloping surface being greater than a height of the sloping surface, with the lateral extent extending, parallel with the skin-contacting surface, from the tip region to a first point aligned with the lowermost region of the sloping surface, and with the height extending, normal to the skin-contacting surface, from the tip region to a second point aligned with the lowermost region. The lateral extent may, for instance, be at least two times greater than the height. Alternatively or additionally, the lateral extent may be at least 200 μm while the height is 100 μm or less.

It is reiterated that by the lateral extent being greater than the height, the sloping surface declines relatively gradually from the tip region to the lowermost region of the sloping surface, thereby assisting gliding of hair thereon towards the cutting element-facing surface.

In some examples, the sloping surface may comprise of a ramped planar region.

In some embodiments, the teeth comprise a first set of teeth that extend, transverse to the main axis, in a first direction, and a second set of teeth that extend, transverse to the main axis, in a second direction opposite to the first direction. The first and second sets of teeth enable the hair-guiding element to guide hair towards the cutting element-facing surface when the hair-guiding element is moved in opposite directions across the skin.

The at least some of the teeth (that each include the part of the hair-guiding surface and the tip region at which the tooth thickness is less than 250 μm) can be included in the first set of teeth and in the second set of teeth.

The hair-lifting and hair-guiding attributes of the tip region and the hair-guiding surface can accordingly be exhibited when moving the hair-guiding element in each of the opposite directions across the skin.

In some embodiments, slots separating neighboring teeth from each other along the main axis comprise pairs of slots, with each of the pairs of slots comprises of a longer slot and a shorter slot. In such embodiments, the longer slot and the shorter slot of each pair may extend along a common slot axis that is transverse to the main axis, with one of the longer slot and the shorter slot being defined between neighboring teeth of the first set of teeth, and the other of the longer slot and the shorter slot being defined between neighboring teeth of the second set of teeth.

In other words, the shorter slot and the longer slot of each of the pairs of slots may be in a back-to-back arrangement such that the shorter slot receives hair along a direction opposite to a direction along which the longer slot receives hair.

As the skin-contacting surface of the hair-guiding element is being moved over the skin, hair can be received in the slots and subsequently reach the cutting element-facing surface. The longer slot can provide more opportunity for hair, particularly longer hair, to be received thereinto, thereby helping to enhance cutting efficiency. However, providing two relatively long slots in a back-to-back arrangement can risk making a width of the hair-guiding element excessively large, which can reduce compactness of a shaver head of an electric shaver in which such a hair-guiding element is included, and hence can compromise application of the hair-guiding element to relatively narrow regions of skin, such as between the nose and upper lip.

The pairs of back-to-back longer and shorter slots may accordingly balance efficient cutting of longer hair with compactness of design of the hair-guiding element.

It is noted that the length of each slot may be defined along a central slot axis that extends transverse to the main axis and bisects the slot, from a connecting region, that connects the neighboring teeth between which the respective slot is defined, to a point located between extremities/end surfaces of the neighboring teeth.

In some embodiments, the hair-guiding element comprises a spinal portion, from which spinal portion the first set of teeth extend, transverse to the main axis, in the first direction, and from which spinal portion the second set of teeth extend, transverse to the main axis, in the second direction, wherein the spinal portion has a meandering shape that causes longer and shorter slots to alternate along the first set of teeth while shorter and longer slots alternate along the second set of teeth. In such embodiments, the balance between efficiently cutting longer hair with compactness of design may be provided along the length of the spinal portion of the hair-guiding element.

In some embodiments, the skin-contacting surface is at least partly delimited by a rounded edge part that convexly curves towards the cutting element-facing surface. The convex curvature of the rounded edge part can assist to enhance comfort when the user is moving the hair-guiding element across the skin. This is because of the convex curvature helping to relieve or eliminate a scratch sensation that can otherwise be experienced by the user in a scenario in which no such convexly curving rounded edge part is included in the hair-guiding element.

In some embodiments, the rounded edge part has a radius of curvature of at least 30 μm, for example at least 50 μm. Such a minimum radius of curvature can provide particularly enhanced comfort to the user when moving the hair-guiding element across their skin.

According to a second aspect of the present disclosure, there is provided a hair-cutting assembly comprising: the hair-guiding element according to any of the embodiments described herein; and a cutting element arranged to face the cutting element-facing surface.

For example, the cutting element-facing surface may contact the cutting element, but with the hair-guiding surface not making contact with the cutting element.

The cutting element may comprise a plurality of cutting portions, with gaps between each neighboring pair of cutting portions. Hair can be cut between first edges of the cutting portions and second edges of the parts of the cutting element-facing surface belonging to the teeth of the hair-guiding element.

In some embodiments, the first edges of the cutting portions are sharper than the second edges of the parts of the cutting element-facing surface.

According to a third aspect of the present disclosure, there is provided an electric shaver comprising: the hair-cutting assembly according to any of the embodiments described herein; and a motorized drive system for moving the cutting element.

The motorized drive system may move the cutting element over the cutting element-facing surface, along an axis parallel with the main axis of the hair-guiding element, in a reciprocating manner.

This movement may cause hairs to be cut between the cutting element and the hair-guiding element.

In some embodiments, the hair-cutting assembly is arranged, in a shaver head of the electric shaver, adjacent to at least one further hair-cutting assembly.

For example, the hair-cutting assembly is arranged, in the shaver head of the electric shaver, adjacent to at least one further hair-cutting assembly comprising a perforate foil and an undercutter arranged to cut hair that protrudes through openings of the perforate foil.

Such a perforate foil-undercutter arrangement of the further hair-cutting assembly can assist in cutting shorter hairs while the hair-cutting assembly (that comprises the hair-guiding element and the cutting element) may be for cutting longer hairs.

In some embodiments, the hair-cutting assembly is arranged in-between a first further hair-cutting assembly and a second further hair-cutting assembly.

In such embodiments, the first further hair-cutting assembly may comprise a first perforate foil and a first undercutter arranged to cut hair that protrudes through first openings of the first perforate foil, with the second further hair-cutting assembly comprising a second perforate foil and a second undercutter arranged to cut hair that protrudes through second openings of the second perforate foil.

According to a fourth aspect of the present disclosure, there is provided a method of manufacturing the hair-guiding element according to any of the embodiments described herein, the method comprising etching a metallic substrate to form at least part of the hair-guiding element.

The hair-guiding element may be formed from etching a stainless steel substrate. In other words, the method may comprise etching such a stainless steel substrate to form at least part of the hair-guiding element.

In some embodiments, an etch-resistant material is arranged on the metallic substrate to mask the metallic substrate, through which etch-resistant material apertures are defined, wherein the etch-resistant material comprises a continuous region that extends continuously between and surrounds the apertures, wherein the etching comprises delivering an etchant to the metallic substrate through the apertures so that discrete recessed regions in the metallic substrate are etched beneath the apertures, the etch-resistant material being resistant to the etchant, and wherein the etching is continued until at least some of the discrete recessed regions merge beneath the continuous region of the etch-resistant material to form one or more merged etched regions with a portion of the metallic substrate still remaining beneath the one or more merged etched regions following the etching.

In such embodiments, the forming of the one or more merged etched regions may, for example, be included in forming of the hair-guiding surface and the tip regions of the hair-guiding element.

This can provide an advantageous way of realizing the hair-guiding element using a method that comprises, for example, a single etching step.

The metallic substrate may have a first thickness prior to the etching, with the etching being continued until the thickness of the metallic substrate is reduced so that the metallic substrate has one or more second thickness beneath the one or more merged etched regions, and with the one or more second thicknesses being non-zero but smaller than the first thickness.

In some embodiments, the etching is continued until the portion beneath the one or more merged etched regions comprises a planar region of the etched metallic substrate, which planar region is disposed beneath at least some of the apertures and beneath where the continuous region of the etch-resistant material extends between the at least some of the apertures.

In some embodiments, the apertures can include larger and smaller apertures, with the larger aperture(s) allowing more of the etchant to pass therethrough to reach the metallic substrate than the smaller aperture(s) during the etching.

In such embodiments, the larger aperture(s) and smaller aperture(s) may, for example, be arranged relative to each other so that the etching provides a ramped profile, for example a ramped planar region, that inclines from a lower region of the etched metallic substrate where more of the metallic substrate is removed beneath the larger aperture(s) to an upper region of the etched metallic substrate where less of the metallic substrate is removed beneath the smaller aperture(s).

The provision of the ramped profile in this manner can be included in forming of the sloping surface of the hair-guiding element.

In some embodiments, one or more non-masked regions is/are provided adjacent to where the etch-resistant material is masking the metallic substrate, with the etching being continued until the metallic substrate is entirely removed by the etching beneath the one or more non-masked regions but with the portion of the metallic substrate still remaining beneath the one or more merged etched regions.

Thus, a single etching step can be used to etch the metallic substrate entirely through its thickness beneath the non-masked regions but only partially etch the metallic substrate at the merged etched region(s).

In some embodiments, the continuous region is connected to a peripheral region of the etch-resistant material, with the continuous region remaining connected to the peripheral region following the etching of the material when the one or more merged etched regions is/are formed.

The peripheral region can assist to retain the continuous region in place during the etching, so as to reduce the risk of the continuous region being removed during the etching and concomitant unintentional over-etching of the metallic substrate.

At least some of the apertures may be arranged in an ordered pattern; and/or at least some of the apertures may be distributed in an irregular manner.

In some embodiments, the ordered pattern comprises an array of apertures. The ordered pattern may comprise, for example, at least one of a rectangular array of apertures and a hexagonal array of apertures.

In the hexagonal array, each aperture is spaced by a single distance from its six nearest neighboring apertures. The hexagonal array can accordingly help to provide relatively uniform etching in the merged etched region beneath the hexagonal array of apertures.

In some embodiments, an open area of the continuous region is 25% or less, for example is in the range of 0.01% to 25%, such as 1% to 25%, with the open area being determined by (i) obtaining a fraction by dividing a total area of the apertures by a total area of the etch-resistant material in which the continuous region and the apertures are provided, and (ii) multiplying the fraction by 100.

Such a maximum 25% open area can assist to minimize the risk of over-etching of the metallic substrate.

The method may comprise removing the etch-resistant material to leave an etched metallic substrate comprising the one or more merged etched regions with the portion of the metallic substrate still remaining beneath the one or more merged etched regions.

In some embodiments, the etching comprises spraying the metallic substrate, with the etch-resistant material arranged thereon, with the etchant. Alternatively or additionally, the etching may comprise moving the metallic substrate, with the etch-resistant material arranged thereon, through an etching zone in which the etchant is delivered to the metallic substrate.

The etchant may comprise at least one selected from a ferric chloride solution, a copper sulfate solution, a nitric acid solution, and a picric acid solution. Such etchants may be particularly well-suited for etching stainless steel.

In some embodiments, the etch-resistant material is arranged on an unetched surface of the metallic substrate. For instance, the etch-resistant material may be arranged on surface(s) of the metallic substrate that have been surface-treated, for instance cleaned, but not etched by a previous etching process.

### BRIEF DESCRIPTION OF THE DRAWINGS

FIG. 1A provides a perspective view of a hair-cutting assembly according to an example;

FIG. 1B provides a cutaway view of the hair-cutting assembly shown in FIG. 1A;

FIG. 1C provides an enlarged cutaway view of the hair-cutting assembly shown in FIG. 1A;

FIG. 1D provides another enlarged cutaway view of the hair-cutting assembly shown in FIG. 1A;

FIG. 1E provides a plan view of a hair-guiding element of the hair-cutting assembly shown in FIG. 1A, viewed from in front of a skin-contacting surface of the hair-guiding element;

FIG. 2 provides a first cross-sectional view of the hair-guiding element shown in FIG. 1E;

FIG. 3A provides an enlarged plan view of part of the hair-guiding element shown in FIG. 1E, with an inset providing a perspective view of a hair on a hair-guiding surface of the hair-guiding element;

FIG. 3B schematically depicts movement of the hair-guiding element shown in FIG. 1E across skin;

FIG. 4A provides a second cross-sectional view of the hair-guiding element shown in FIG. 1E;

FIG. 4B provides an enlarged diagram showing part of the second cross-sectional view provided in FIG. 4A;

FIG. 5 replicates the second cross-sectional view provided in FIG. 4A and shows a hair being guided by the hair-guiding surface of the hair-guiding element;

FIG. 6 shows part of a hair-guiding element according to another example;

FIG. 7A shows part of a hair-guiding element according to an example in which a step is defined between the hair-guiding surface and a cutting element-facing surface of the hair-guiding element;

FIG. 7B provides an enlarged diagram showing part of the hair-guiding element shown in FIG. 7A;

FIG. 8 replicates the second cross-sectional view provided in FIG. 7A and shows a hair being guided by the hair-guiding surface of the hair-guiding element;

FIG. 9 provides an enlarged plan view of part of the hair-guiding element shown in FIG. 1E, with an inset providing a perspective view of a hair between teeth of the hair-guiding element;

FIG. 10 shows a foil of an electric shaver according to an example;

FIGS. 11A and 11B schematically depict processes of etching a metallic substrate;

FIG. 12 provides a schematic cross-sectional view showing delivery of an etchant and progressive removal of regions of a metallic substrate by the etchant;

FIG. 13 provides a schematic cross-sectional view showing delivery of an etchant to one side of a metallic substrate;

FIG. 14 schematically depicts an etch-resistant material arranged on a metallic substrate (left) and the resulting etched metallic substrate (right) according to an example;

FIG. 15 schematically depicts an etch-resistant material arranged on a metallic substrate (left) and the resulting etched metallic substrate (right) according to another example;

FIG. 16 schematically depicts an etch-resistant material arranged on a metallic substrate (left) and the resulting etched metallic substrate (right) according to still another example;

FIG. 17 provides a cutaway view of a hair-cutting assembly whose hair-guiding element is fabricated using an etching method according to an example;

FIG. 18 schematically depicts an etch-resistant material arranged on a metallic substrate (left) and the resulting etched metallic substrate (right) according to yet another example;

FIG. 19 schematically depicts an etch-resistant material arranged on a metallic substrate (left) and the resulting etched metallic substrate (right) according to a further example;

FIG. 20 provides a cutaway view of another hair-cutting assembly whose hair-guiding element is fabricated using an etching method according to an example.

FIG. 21 provides a plan view of an etch-resistant material that delimits a rectangular array of apertures through which etchant is deliverable to a metallic substrate;

FIG. 22 provides a plan view of an etch-resistant material that delimits a hexagonal array of apertures through which etchant is deliverable to a metallic substrate;

FIG. 23 provides a plan view of an etch-resistant material that delimits irregularly distributed apertures through which etchant is deliverable to a metallic substrate; and

FIG. 24 provides a plan view of an etch-resistant material that delimits smaller and larger apertures through which etchant is deliverable to a metallic substrate.

### DETAILED DESCRIPTION OF THE INVENTION

Provided is a hair-guiding element for an electric shaver. The hair-guiding element has a skin-contacting surface for contacting skin, and a cutting element-facing surface for facing a cutting element, with the cutting element-facing surface facing in an opposite direction with respect to a direction faced by the skin-contacting surface. The hair-guiding element's periphery provides the hair-guiding element with a toothed profile comprising teeth arranged along a main axis of the hair-guiding element, with the teeth each comprising part of the skin-contacting surface and part of the cutting element-facing surface.

Further provided is a hair-cutting assembly comprising the hair-guiding element and the cutting element, and an electric shaver comprising such a hair-cutting assembly. Additionally provided is a method of manufacturing the hair-guiding element.

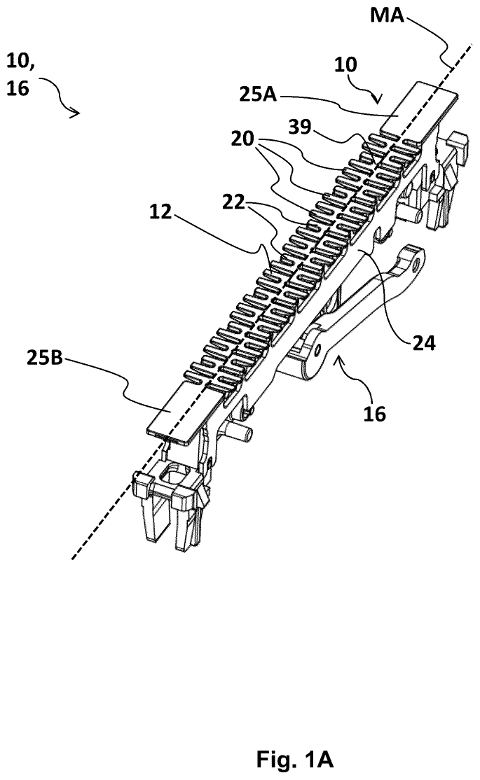

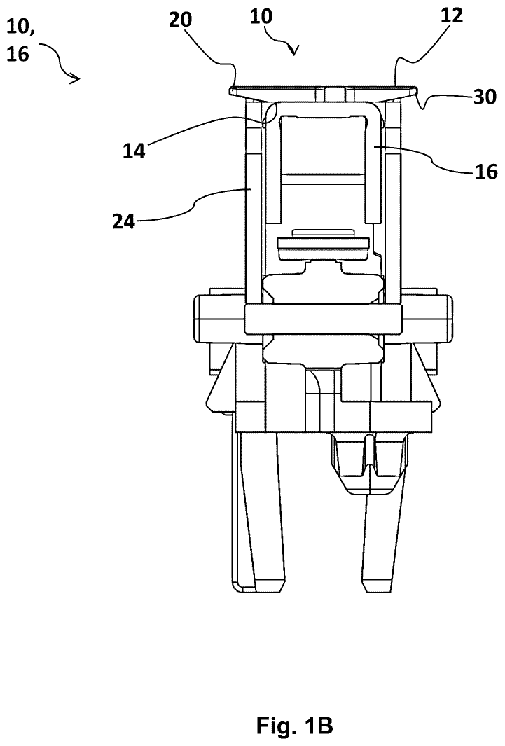

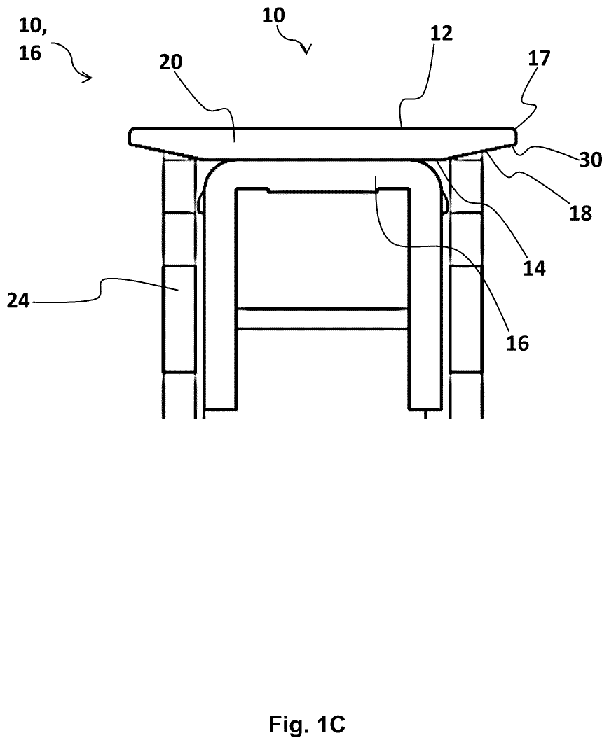

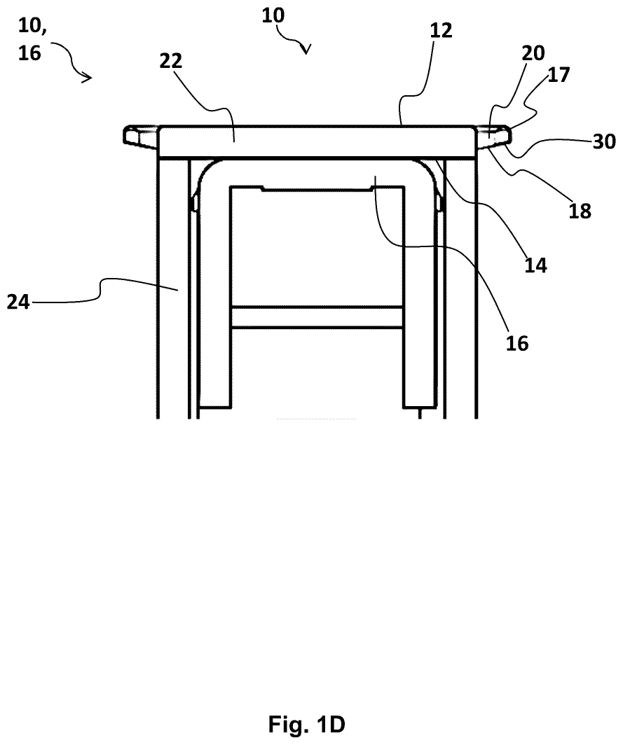

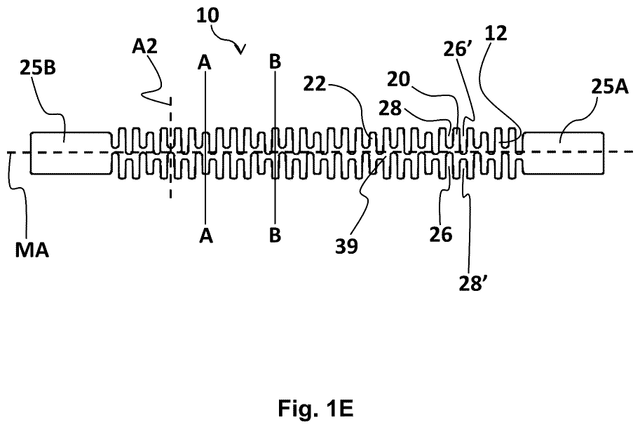

FIGS. 1A to 1D provide various views of a hair-cutting assembly 10, 16 according to an example. The hair-cutting assembly 10, 16 can be used, for example included, in an electric shaver. The hair-cutting assembly 10, 16 comprises a hair-guiding element 10 for guiding hair prior to the hair being cut by the hair-cutting assembly 10, 16.

The hair-guiding element 10 may include a skin-contacting surface 12 for contacting skin (not visible in FIGS. 1A to 1D), and a cutting element-facing surface 14 for facing a cutting element 16, which cutting element 16 may be included, together with the hair-guiding element 10, in the cutting assembly 10, 16. The cutting element-facing surface 14 may face in an opposite direction with respect to a direction faced by the skin-contacting surface 12.

As well as facing the cutting element 16, the cutting element-facing surface 14 may contact the cutting element 16 when the hair-guiding element 10 is arranged, together with the cutting element 16, in the hair-cutting assembly 10, 16.

A motorized drive system included in the electric shaver may move the cutting element 16 over the cutting element-facing surface 14, for example while the cutting element-facing surface 14 is in contact with the cutting element 16, along an axis parallel with a main axis MA of the hair-guiding element 10, in a reciprocating manner.

This movement may cause hairs to be cut between the cutting element 16 and the hair-guiding element 10.

It is noted that the hair-guiding element 10 can be regarded as an outer cutter, outer blade or comb, with the cutting element 16 being an inner cutter or inner blade. Hair can be cut between a first edge of the hair-guiding element 10 and a second edge of the cutting element 16. The second edge of the cutting element 16 can, for example, be sharper, in other words have a smaller radius of curvature, than the first edge of the hair-guiding element 10. Alternatively, it is conceivable for the first edge of the hair-guiding element 10 to be sharper, in other words have a smaller radius of curvature, than the second edge of the cutting element 16.

As shown in FIG. 1C, the skin-contacting surface 12 may be at least partly delimited by a rounded edge part 17 that convexly curves towards the cutting element-facing surface 14.

The convex curvature of the rounded edge part 17 can assist to enhance comfort when a user is moving the hair-guiding element 10 across the skin. This is because of the convex curvature helping to relieve or eliminate a scratch sensation that can otherwise be experienced by the user in a scenario in which no such convexly curving rounded edge part 17 is included in the hair-guiding element 10.

The hair-guiding element 10, for example comb, can be formed of any suitable material, such as a metallic material. Particular mention is made of the hair-guiding element 10 comprising stainless steel. Alternatively or additionally, the cutting element 16, for example inner cutter or inner blade, can comprise a metallic material, such as stainless steel. Particular mention is made of embodiments in which the hair-guiding element 10 comprises stainless steel and the cutting element 16 comprises stainless steel.

In some embodiments, the hair-guiding element 10 and/or the cutting element 16 is/are formed from etching a stainless steel substrate. Etching processes which may be used in fabricating the hair-guiding element 10 and/or the cutting element 16 are described in detail herein below.

Referring to FIGS. 1C and 1D, the hair-guiding element 10 can comprise a hair-guiding surface 18 on which hair from the skin is receivable, so as to be guided on the hair-guiding surface 18, when the skin-contacting surface 12 is in contact with the skin. Hair can be guided along the hair-guiding surface 18 towards the cutting element-facing surface 14, where the hair may be cut between the hair-guiding element 10 and the cutting element 16.

It is noted that the hair-guiding surface 18 may be distinguished from the cutting element-facing surface 14 (at least) in that the cutting element-facing surface 14 may contact the cutting element 16 while the hair-guiding surface 18 does not contact the cutting element 16.

Embodiments relating to design and fabrication of the hair-guiding element 10 having such a hair-guiding surface 18 are described in more detail herein below.

In some embodiments, and referring to FIGS. 1A and 1E, the hair-guiding element 10 has a periphery that provides the hair-guiding element 10 with a toothed profile comprising teeth 20 arranged along the main axis MA of the hair-guiding element 10. Hair can be captured and cut between the teeth 20 of the hair-guiding element 10. It is noted that embodiments in which the hair-guiding element 10 includes such a toothed profile, the hair-guiding element 10 can be regarded as a comb.

The teeth 20 may each comprise part of the skin-contacting surface 12 and part of the cutting element-facing surface 14. Accordingly, and referring to FIGS. 1B and 1C, upper surfaces of the teeth 20 may contact the skin, while lower surfaces of the teeth 20 face, and for example contact, the cutting element 16.

It is noted that the terms “upper” and “lower” as used in this context refer to the orientation shown, for example, in FIGS. 1B and 1C. This orientation may be appropriate when, for example, the hair-guiding element 10 is being used to cut hairs under the chin, with the skin-contacting surface 12 facing upwardly to contact skin under the chin, but it will be appreciated that the hair-guiding element 10, the hair-cutting assembly 10, 16 and the electric shaver comprising the hair-cutting assembly 10, 16 can be orientated in any suitable manner in order for the skin-contacting surface 12 to contact skin at any given location, so as to enable cutting of hair growing therefrom.

The cutting element 16 may comprise a plurality of cutting portions, with gaps between each neighboring pair of cutting portions. Hair can be cut between first edges of the parts of the cutting element-facing surface 14 belonging to the teeth 20 of the hair-guiding element 10 and second edges of the cutting portions.

In some embodiments, the second edges of the cutting portions are sharper, in other words have a smaller radius of curvature, than the first edges of the parts of the cutting element-facing surface 14. Alternatively, it is conceivable for the first edges of the parts of the cutting element-facing surface 14 to be sharper, so as to have a smaller radius of curvature, than the second edges of the cutting portions.

The hair-guiding element 10 can be mounted in the hair-cutting assembly 10, 16 in any suitable manner. In some embodiments, and referring to FIGS. 1A and 1D, connecting elements 22 of the hair-guiding element 10 may connect the hair-guiding element 10 to side members 24, for example side members 24 in the form of side sheets, of the cutting assembly 10, 16. The connecting elements 22 support the hair-guiding element 10, to mount it in the hair-cutting assembly 10.

The connection between the connecting elements 22 and the side members 24 can be provided using any suitable attachment technique, for instance by welding, for example laser welding, the connecting elements 22 to the side members 24.

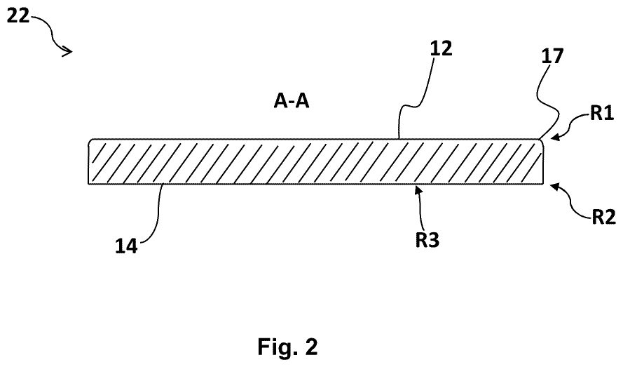

Referring to FIG. 2, which provides a first cross-sectional view A-A of the hair-guiding element 10 shown in FIG. 1E, the connecting elements 22 may each include a portion of the skin-contacting surface 12 and/or may each include a portion of the cutting element-facing surface 14. In such embodiments, the rounded edge part 17 may convexly curve from the portion of the skin-contacting surface 12 towards the portion of the cutting element-facing surface 14.

In some embodiments (not shown), the connecting elements 22 include portions of the hair-guiding surface 18. Alternatively, and as shown in FIGS. 1A to 1E and 2, the teeth 20 include parts of the hair-guiding surface 18 while the connecting elements 22 do not include any portion of the hair-guiding surface 18.

In some embodiments, the connecting elements 22 can be included in the toothed profile, such that hair is receivable in space(s) defined between one of the connecting elements 22 and one of the teeth 20 and/or between neighboring connecting elements 22, as well as between neighboring teeth 20.

Several connecting elements 22 may be provided, to support the hair-guiding element 10 at intervals along the main axis. The connecting elements 22 and the teeth 20 may be interleaved, in a regular or irregular pattern. In some embodiments, between two and five teeth of the first set of teeth may be arranged between successive connecting elements 22. Likewise, between two and five teeth of the second set of teeth may be arranged between successive connecting elements 22. In the particular example shown in FIGS. 1A and 1E, three teeth of the first set and three teeth of the second set are arranged between successive connecting elements 22.

Alternatively or additionally, the connecting elements 22 can be shorter than at least some of the teeth 20, such that said at least some of the teeth 20 extend further, transverse to the main axis MA, than the connecting elements 22.

To identify whether the connecting elements 22 are shorter than the teeth 20, the length of the connecting elements 22 and the teeth 20 may be considered to be the distance from the main axis MA to the extremity of the relevant connecting element 22 or tooth 20 located furthest from the main axis MA (on the same side of the main axis MA).

At least some (optionally all) of the teeth of the first set may have the same length, or substantially the same length. At least some (optionally all) of the teeth of the second set may have the same length, or substantially the same length. (Here, again, the length is measured from the main axis to the extremity of the respective tooth.) “Substantially the same length” may be understood as referring to teeth that differ in length by no more than 10%.

Providing sets of teeth of the same length, on one or both sides of the main axis MA, may help to further optimize the use of space in the shaver head. It can permit the individual teeth to be as long as possible, while minimizing the overall dimension of the hair-guiding element 10 in a direction transverse to the main axis MA.

Nevertheless, in some embodiments, some of the teeth may have different lengths (that is, lengths that differ by more than 10%). In particular, some of the teeth of the first set may have different lengths, and/or some of the teeth of the second set may have different lengths.

The term “transverse to the main axis MA” may mean perpendicular or at least substantially perpendicular to the main axis MA when the hair-guiding element 10 is viewed in plan so that the skin-contacting surface 12 or the cutting element-facing surface 14 is facing the viewer. FIG. 1E shows such a plan view, with the skin-contacting surface 12 facing the viewer. The qualifier “substantially” may refer to a deviation from perpendicular of up to 10°.

It is generally noted in relation to the main axis MA of the hair-guiding element 10, for example comb, that the main axis MA may extend along a length, in other words along a longest dimension, of the hair-guiding element 10 from a first end portion 25A to a second end portion 25B of the hair-guiding element 10.

The main axis MA may, for example, bisect the hair-guiding element 10 so that the main axis MA separates the hair-guiding element 10 into a pair of elongate halves of the hair-guiding element 10.

The end portions 25A, 25B of the hair-guiding element 10 may, for example, be devoid of teeth, such that the toothed profile of the hair-guiding element 10 extends between, without being included in, the end portions 25A, 25B.

In at least some embodiments, the teeth 20 comprise a first set of teeth that extend, transverse to the main axis MA, in a first direction, and a second set of teeth that extend, transverse to the main axis MA, in a second direction opposite to the first direction. The first and second sets of teeth enable the hair-guiding element 10 to guide hair towards the cutting element-facing surface 14 when the hair-guiding element 10 is moved in opposite directions across the skin.

Implicit in the toothed profile of the hair-guiding element 10 is that slots 26, 26′, 28, 28′ separate neighboring teeth 20 from each other along the main axis MA.

In embodiments in which the teeth 20 comprise the first set of teeth and the second set of teeth, the slots 26, 26′, 28, 28′ can include slots 26, 28′ that separate neighboring teeth of the first set of teeth from each other, and slots 26′, 28 that separate neighboring teeth of the second set of teeth from each other.

Alternatively or additionally, the slots 26, 26′, 28, 28′ may comprise first slots 26, 26′ and second slots 28, 28′ that differ from each other (at least) in terms of their length transverse to the main axis MA. Embodiments in which such first and second slots 26, 26′, 28, 28′ of differing length are provided in the hair-guiding element 10 are described in more detail herein below.

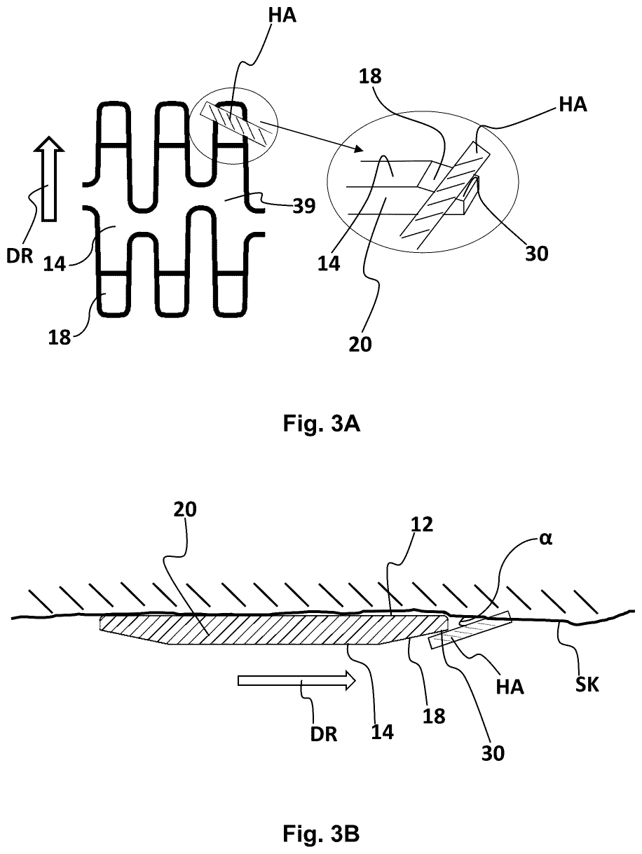

In some embodiments, and referring now to FIGS. 1B to 1D, 3A and 3B, at least some of the teeth 20, for example said at least some of the teeth 20 that extend further, transverse to the main axis MA, than the connecting elements 22, each comprise a part of the hair-guiding surface 18 and a tip region 30 that is arranged to receive hair HA thereon when the hair-guiding element 10 is moved over the skin SK. The part of the hair-guiding surface 18 may extend, in a direction transverse to the main axis MA, away from the tip region 30 and towards the part of the cutting element-facing surface 14 so as to enable the part of the hair-guiding surface 18 to guide the hair HA that has been received on the tip region 30 towards the part of the cutting element-facing surface 14.

As shown in FIGS. 3A and 3B, when the hair-guiding element 10 is moved over the skin SK in the direction denoted by the arrow DR, with the skin-contacting surface 12 contacting the skin SK, hair HA may ride up (relative to the surface of the skin SK) onto the tip region 30 and glide along the part of the hair-guiding surface 18 towards the part of the cutting element-facing surface 14.

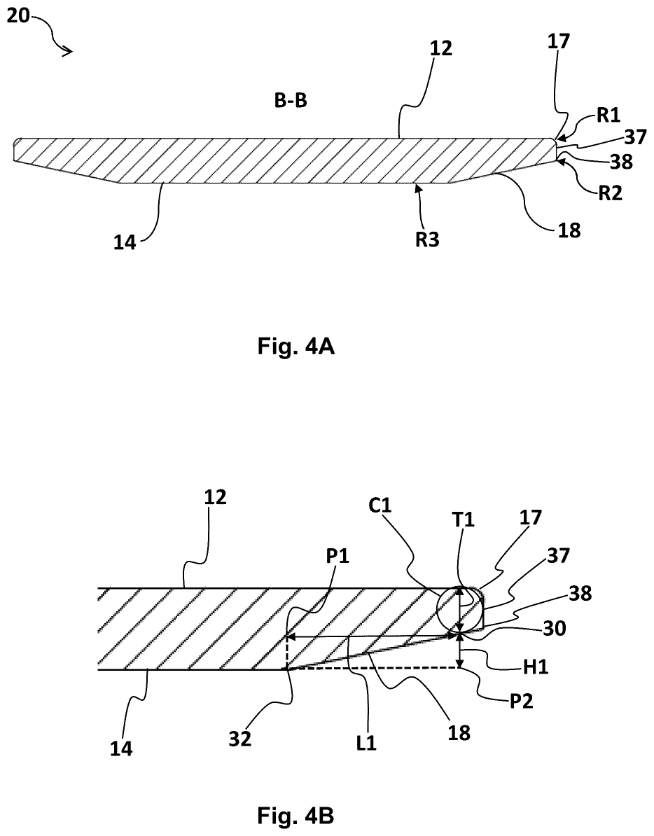

The part of the hair-guiding surface 18 is also evident in FIGS. 4A and 4B, noting that FIG. 4A provides a second cross-sectional view B-B of the hair-guiding element 10 shown in FIG. 1E. FIG. 4B provides an enlarged diagrammatic view which shows, among other things, the tip region 30.

Users of conventional electric shavers can find that hair HA can remain uncut despite a comb of the electric shaver being moved over the skin SK at the location where such hair HA is present. This can lead to the user moving the comb over the skin SK at the same location multiple times, which can cause skin irritation.

Referring again to FIG. 3B, it has been found that one reason for hair HA remaining uncut is the angle α of hair HA relative to the surface of the skin SK, and in particular a relatively small angle α relative to the surface of the skin SK. For example, hair HA on the neck can protrude from the skin surface at an angle α of only around 10°.

Accordingly, and referring to FIG. 4B, a tooth thickness T1 at the tip region may be less than 250 μm, which tooth thickness T1 is a diameter of a smallest notional circle C1 whose circumference is intersected by both the part of the hair-guiding surface 18 and the part of the skin-contacting surface 12, with the smallest notional circle's C1 plane being perpendicular to the main axis MA. As should be apparent from the example in FIG. 4B, the use of the “smallest notional circle” to measure the tooth thickness T1 does not require that the tip region has a circular geometry.

By the tooth thickness T1 at the tip region 30 being less than 250 μm, preferably less than 200 μm, it has been found that more hair HA can be successfully cut in fewer passes of the hair-guiding element 10 across the skin SK, resulting in less skin irritation. This is because a tooth 20 whose thickness T1 at the tip region 30 being less than 250 μm can enter a gap of around 260 μm between an end of a hair HA and the surface of the skin SK when the hair HA protrudes from the surface of the skin SK at an angle α of about 10° and the hair HA is about 1.5 mm in length, which corresponds to an upper limit of facial hair growth in 3 days (0.5 mm per day).

It is generally noted at this point that the skin-contacting surface 12 may have a single plane, with the circumference, of the smallest notional circle C1 whose diameter defines the tooth thickness T1, being intersected by the single plane of the skin-contacting surface 12.

The at least some of the teeth 20 (that each include the part of the hair-guiding surface 18 and the tip region 30 at which the tooth thickness T1 is less than 250 μm) can be included in the first set of teeth and in the second set of teeth.

Thus, the hair-lifting and hair-guiding attributes of the tip region 30 and the hair-guiding surface 18 can accordingly be exhibited when moving the hair-guiding element 10 in each of the opposite directions across the skin SK.

In some embodiments, and referring to FIGS. 3A, 3B, 4A, 4B, 5 and 6, the part of the hair-guiding surface 18 of the at least some of the teeth 20 comprises a sloping surface that declines, as the sloping surface extends transverse to the main axis MA, from the tip region 30 towards the part of the cutting element-facing surface 14, with the sloping surface becoming further from the skin-contacting surface 12 as the sloping surface declines towards the part of the cutting element-facing surface 14.

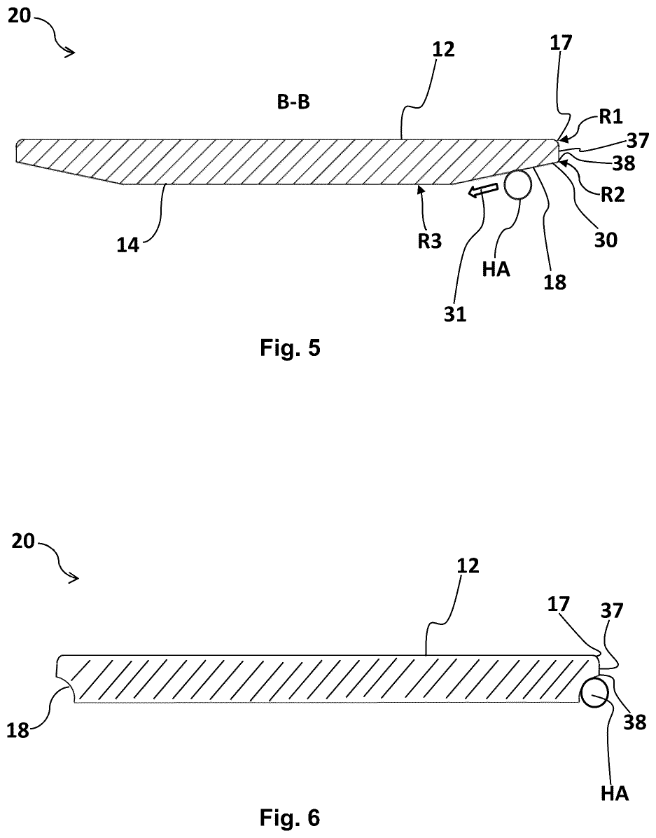

Thus, and referring to FIG. 5, the hair HA received on the tip region 30 can glide down the sloping surface, in the direction indicated by the arrow 31, towards the cutting element-facing surface 14. Separating hair HA from the skin SK in this manner can assist to appropriately orientate the hair HA for cutting as the hair HA glides down the sloping surface towards the cutting element-facing surface 14.

The sloping surface can be regarded, for instance, as a chamfer for transporting the hair HA to a cutting plane defined by the cutting element-facing surface 14. Thus, after being lifted onto the tip region 30, the hair HA may be transported along the sloping surface/chamfer where the hair HA can be cut, upon reaching the cutting element-facing surface 14, between the hair-guiding element 10 and the cutting element 16.

It is reiterated that the hair-guiding surface 18 may not come into contact with the cutting element 16, and, in the case of embodiments in which the hair-guiding surface 18 comprises the sloping surface, the sloping surface may not come into contact with the cutting element 16.

Alternatively or additionally, said at least some of the teeth 20 that include the sloping surface may extend further, transverse to the main axis MA, than the connecting elements 22. For example, the at least some of the teeth 20 comprising the sloping surface may jut out from the side members 24 of the hair-cutting assembly 10, 16, whereas extremities of the connecting elements 22 may be flush with the side members 24, or at least protrude to a lesser extent from the side members 24 in comparison to the at least some of the teeth 20 that comprise the sloping surface.

Portions of the at least some of the teeth 20 that protrude further, transverse to the main axis MA, than the connecting elements 22 can include the tip portion 30 and at least a fraction of the sloping surface.

In some embodiments, and referring to FIG. 4B, a lowermost region 32 of the sloping surface is where the sloping surface reaches, in a stepless manner, the cutting element-facing surface 14. Thus, hair HA can continuously glide down the sloping surface to reach the cutting element-facing surface 14.

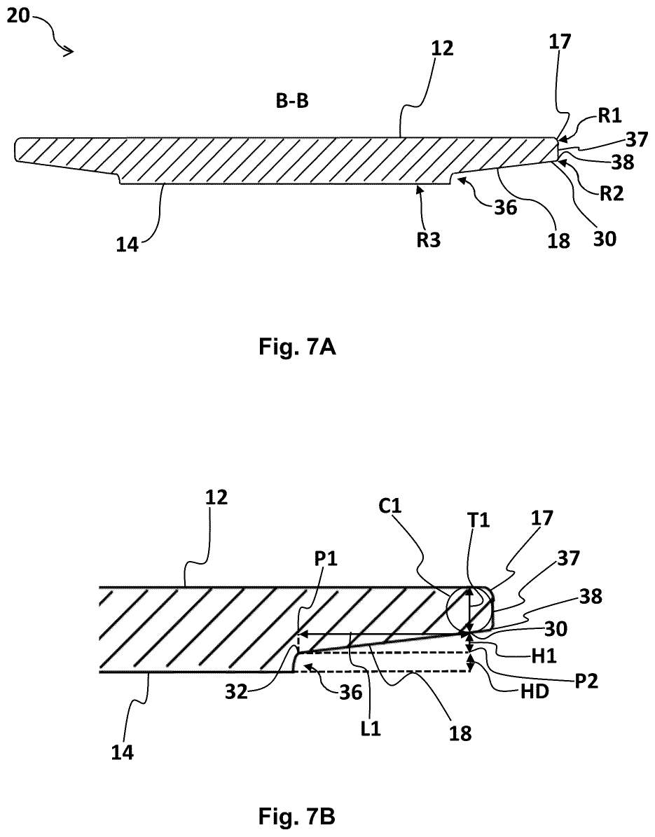

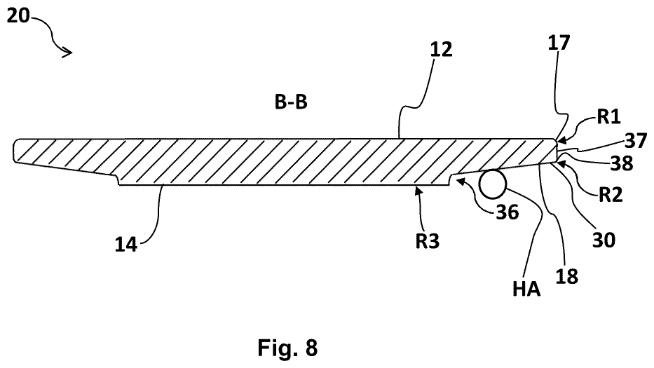

This can facilitate guiding of hair HA to the cutting element-facing surface 14, particularly relative to embodiments, such as shown in FIGS. 7A, 7B and 8, in which the hair HA is required to surmount a step 36 defined between the part of the cutting element-facing surface 14 and the lowermost region 32 of the sloping surface.

It is noted that whether or not such a step 36 is defined between the part of the cutting element-facing surface 14 and the lowermost region 32 of the sloping surface may depend on the technique(s) used to create the sloping surface, for example chemical etching, electrochemical etching (ECM), precision (or pulsed) electrochemical machining (PECM), laser removal, and/or wire cutting. A chemical etching method which can be used to attain the sloping surface of the hair-guiding element 10 is described in detail below.

In some embodiments, and referring to FIG. 4B, the sloping surface has a gradient defined by a lateral extent L1 of the sloping surface being greater than a height H1 of the sloping surface, with the lateral extent L1 extending, parallel with the skin-contacting surface 12, from the tip region 30 to a first point P1 aligned with the lowermost region 32 of the sloping surface, and with the height H1 extending, normal to the skin-contacting surface 12, from the tip region 30 to a second point P2 aligned with the lowermost region 32.

By the lateral extent L1 being greater than the height H1, the sloping surface declines relatively gradually from the tip region 30 to the lowermost region 32 of the sloping surface, for example compared to a scenario in which the lateral extent L1 is the same as or is smaller than the height H1, as in the example shown in FIG. 6.

Such a relatively gradually declining sloping surface can assist gliding of hair HA thereon towards the cutting element-facing surface 14.

In some embodiments, the lateral extent L1 is at least two times greater than the height H1. Alternatively or additionally, the lateral extent L1 may be at least 200 μm while the height H1 is 100 μm or less.

In the case of embodiments in which the step 36 is defined between the lowermost region 32 of the declining sloping surface and the part of the cutting element-facing surface 14, as shown in FIGS. 7A, 7B and 8, the step 36 may provide a height difference HD between the part of the cutting element-facing surface 14 and the lowermost region 32 of no more than 50 μm, for example no more than 40 μm.

In such embodiments, hair HA may glide down the sloping surface until the hair HA reaches the step 36, at which point the gliding movement of the hair HA may be terminated, but with the hair HA being able to surmount the step 36, for example by being bumped or rolling over onto the part of the cutting element-facing surface 14 from the lowermost region 32 of the sloping surface.

By limiting this height difference HD to no more than 50 μm, an average hair HA that has glided down the sloping surface to reach the lowermost region 32 can relatively easily surmount the step 36. This is because the height difference HD does not exceed half of an average value of the diameter of a facial hair HA, in other words 50 μm.

In embodiments in which the step 36 is defined between the lowermost region 32 of the declining sloping surface and the part of the cutting element-facing surface 14, and referring to FIG. 7B, the sloping surface may have a gradient defined by a lateral extent L1 of the sloping surface being greater than a height H1 of the sloping surface, with the lateral extent L1 in this case extending, parallel with the skin-contacting surface 12, from the tip region 30 to a first point P1 aligned with the lowermost region 32 of the sloping surface at a base of the step 36, and with the height H1 extending, normal to the skin-contacting surface 12, from the tip region 30 to a second point P2 aligned with the lowermost region 32. For example, the lateral extent L1 is at least two times greater than the height H1. Alternatively or additionally, the lateral extent L1 may be at least 200 μm while the height H1 is 100 μm or less.

It is reiterated that by the lateral extent L1 being greater than the height H1, the sloping surface declines relatively gradually from the tip region 30 to the lowermost region 32 of the sloping surface, thereby assisting gliding of hair HA thereon towards the cutting element-facing surface 14.

In embodiments in which the rounded edge part 17 convexly curves from the part of the skin-contacting surface 12 towards the part of the cutting element-facing surface 14, and referring now to FIGS. 4A, 5, 7A and 8, the rounded edge part 17 may have a radius of curvature R1 of at least 30 μm, for example at least 50 μm. Such a minimum radius of curvature R1 of the rounded edge part 17 can provide particularly enhanced comfort to the user when moving the hair-guiding element 10 across their skin SK.

The rounded edge part 17, for instance the rounded edge part 17 having the radius of curvature R1 of at least 30 μm, such as at least 50 μm, may be provided around an entire perimeter of the hair-guiding element 10.

In some embodiments, the rounded edge part 17, for instance the rounded edge part 17 having the radius of curvature R1 of at least 30 μm, such as at least 50 μm, may be included in the teeth 20 and in the connecting elements 22.

The radius of curvature R1 of the rounded edge part 17, for instance the rounded edge part 17 of the teeth 20 and the rounded edge part 17 of the connecting elements 22, may be in the range of 30 μm to 70 μm.

In some embodiments, and referring to FIGS. 4A, 4B, 5, 6, 7A, 7B and 8, the teeth 20 each comprise an end surface 37 and the rounded edge part 17 convexly curves from the part of the skin-contacting surface 12 to the end surface 37.

Part of the end surface 37 may, for example, be intersected by the circumference, of the smallest notional circle C1 whose diameter defines the tooth thickness T1.

A further edge part 38 may be defined between the end surface 37 and the part of the hair-guiding surface 18. The further edge part 38 can, for instance, have a radius of curvature R2 of at least 7 μm.

Such a minimum radius of curvature R2 of the further edge part 38 can assist to minimize or prevent catching of hair HA on the further edge part 38 when the hair-guiding element 10 is being moved over the skin SK.

The radius of curvature R2 of the further edge part 38 may, for example, be in the range of 7 μm to 13 μm.

In some embodiments, the radius of curvature R1 of the rounded edge part 17 is at least 30 μm and the radius of curvature R2 of the further edge part 38 is at least 7 μm.

For example, the radius of curvature R1 of the rounded edge part 17 is at least 50 μm and the radius of curvature R2 of the further edge part 38 is at least 7 μm. In a non-limiting example, the radius of curvature R1 of the rounded edge part 17 is in the range of 30 μm to 70 μm, and the radius of curvature R2 of the further edge part 38 is in the range of 7 μm to 13 μm.

It is reiterated that hair HA may be cut between the first edge of the hair-guiding element 10 and the second edge of the cutting element 16. In some embodiments, a radius of curvature R3 of the first edge of the hair-guiding element 10 is at most 3.5 μm, for example is 1 μm to 3.5 μm.

Such a maximum radius of curvature R3 of the first edge can assist cutting of hair HA thereagainst.

In some embodiments, the radius of curvature R1 of the rounded edge part 17 is at least 30 μm, and the radius of curvature R3 of the first edge of the hair-guiding element 10 is at most 3.5 μm. For example, the radius of curvature R1 of the rounded edge part 17 is at least 50 μm, and the radius of curvature R3 of the first edge of the hair-guiding element 10 is at most 3.5 μm.

In some embodiments, the radius of curvature R2 of the further edge part 38 is at least 7 μm, and the radius of curvature R3 of the first edge of the hair-guiding element 10 is at most 3.5 μm. For example, the radius of curvature R2 of the further edge part 38 is in the range of 7 μm to 13 μm, and the radius of curvature R3 of the first edge of the hair-guiding element 10 is in the range of 1 μm to 3.5 μm.

In some embodiments, the radius of curvature R1 of the rounded edge part 17 is at least 30 μm, the radius of curvature R2 of the further edge part 38 is at least 7 μm, and the radius of curvature R3 of the first edge of the hair-guiding element 10 is at most 3.5 μm. For example, the radius of curvature R1 of the rounded edge part 17 is at least 50 μm, the radius of curvature R2 of the further edge part 38 is at least 7 μm, and the radius of curvature R3 of the first edge of the hair-guiding element 10 is at most 3.5 μm.

In a non-limiting example, the radius of curvature R1 of the rounded edge part 17 is in the range of 30 μm to 70 μm, the radius of curvature R2 of the further edge part 38 is in the range of 7 μm to 13 μm, and the radius of curvature R3 of the first edge of the hair-guiding element 10 is in the range of 1 μm to 3.5 μm.

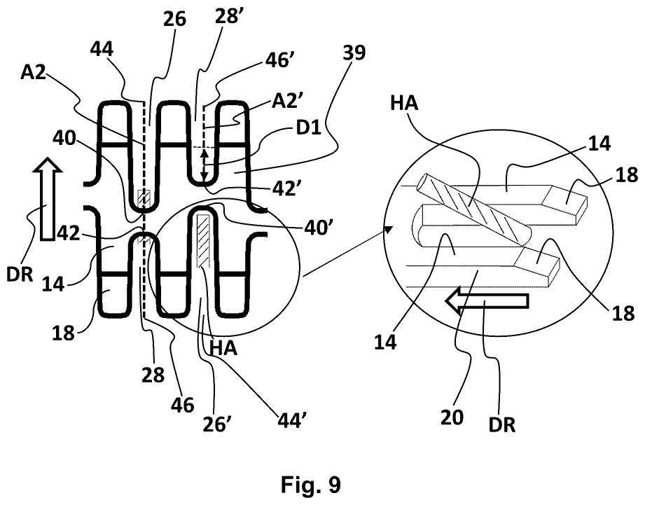

In some embodiments, and referring now to FIG. 9, the slots 26, 26′, 28, 28′ that separate neighboring teeth 20 from each other along the main axis MA comprise pairs of slots 26, 28; 26′, 28′, with each of the pairs of slots 26, 28; 26′, 28′comprising a longer slot 26; 26′ and a shorter slot 28; 28′. The longer slot 26; 26′and the shorter slot 28; 28′ of each pair of slots 26, 28; 26′, 28′ extend along a common slot axis A2; A2′ that is transverse to the main axis MA, with one of the longer slot 26; 26′ and the shorter slot 28; 28′ being defined between neighboring teeth of the first set of teeth, and the other of the longer slot 26; 26′ and the shorter slot 28; 28′ being defined between neighboring teeth of the second set of teeth.

In other words, the shorter slot 28; 28′ and the longer slot 26; 26′ of each of the pairs of slots 26, 28; 26′, 28′ may be in a back-to-back arrangement such that the shorter slot 28; 28′ receives hair HA along a direction opposite to a direction along which the longer slot 26; 26′ receives hair HA.

As the skin-contacting surface 12 of the hair-guiding element 10 is being moved over the skin SK in the direction indicated in FIG. 9 by the arrow DR, hair HA can be received in the slots 26, 28′ and subsequently reach the cutting element-facing surface 14. The longer slot 26; 26′ can provide more opportunity for hair HA, particularly longer hair HA, to be received thereinto, thereby helping to enhance cutting efficiency. However, providing two relatively long slots 26; 26′ in a back-to-back arrangement can risk making a width of the hair-guiding element 10 excessively large, which can reduce compactness of a shaver head of an electric shaver in which such a hair-guiding element 10 is included, and hence can compromise application of the hair-guiding element 10 to relatively narrow regions of skin SK, such as between the nose and upper lip.

The pairs of longer and shorter slots 26, 28; 26′, 28′ may accordingly balance efficient cutting of longer hair HA with compactness of design of the hair-guiding element 10.

In some embodiments, and still referring to FIG. 9, the hair-guiding element 10 comprises a spinal portion 39, from which spinal portion 39 the first set of teeth extend, transverse to the main axis MA, in the first direction, and from which spinal portion 39 the second set of teeth extend, transverse to the main axis MA, in the second direction.

The spinal portion 39 may have a meandering shape that causes longer and shorter slots 26, 28′ to alternate along the first set of teeth while shorter and longer slots 28, 26′ alternate along the second set of teeth. In other words, the spinal portion can include successive segments that are offset from one another in a direction transverse to the main axis.

In such embodiments, the balance between efficiently cutting longer hair HA with compactness of design may be provided along the length of the spinal portion 39 of the hair-guiding element 10.

In the example illustrated, in FIG. 9 all of the teeth are supported exclusively by the spinal portion. Each tooth has the form of a cantilever—supported at one end by the spinal portion and unsupported at the other end (distal from the spinal portion). Such a cantilever form can help the teeth to more effectively lift hair—especially relatively flat-lying hair. It is believed that the combination of any two or more of (i) the cantilevered teeth, (ii) the hair-guiding surface 18, and (iii) the limited tooth thickness T1 at the tip region 30 can provide particularly effective hair-lifting.

It is noted that the length of each slot 26, 26′, 28, 28′ may be defined along a central slot axis A2; A2′ that extends transverse to the main axis MA and bisects the slot 26, 26′, 28, 28′, from a connecting region 40, 40′; 42 42′, that connects the neighboring teeth 20 between which the respective slot 26, 26′, 28, 28′ is defined, to a point 44, 44′; 46, 46′ located between extremities/end surfaces 37 of the neighboring teeth 20.

A distance D1 along the central slot axis A2; A2′ of each slot 26, 26′, 28, 28′ between the connecting region 40, 40′; 42, 42′ to a point aligned with where the part of the cutting element-facing surface 14 terminates may define a cutting length. Without wishing to be bound by theory, it is believed that the cutting length of the slot has a significant influence on the efficiency with which long hairs are cut. As the skin-contacting surface 12 of the hair-guiding element 10 is being moved over the skin SK in the direction indicated in FIG. 9 by the arrow DR, a hair HA may initially be trapped under the spinal portion 39 and pressed against the skin. As the hair-guiding element continues its travel in the direction indicated by DR, the free end of the hair HA is released from beneath the spinal portion 39 and the hair springs up from the skin. As shown in FIG. 9, at the point at which the hair springs upright, the base of the hair (where it meets the skin) is still positioned between two portions of the cutting element-facing surface 14. This means that the hair is suitably positioned to be cut by the cutting element 16 (for example, between the cutting element 16 and the hair guiding element 10).

From this, it can be seen that the length of the slot is correlated with the maximum length of hair HA that can be cut by this mode. This explains, in part, why it is desirable to provide long slots. If the hair HA were longer than the cutting length (defined by the extent of the cutting element-facing surface 14) then, at the point at which the free end of the hair was released from under the spinal portion 39 and sprang upright, the base of the hair might already be located beyond the reach of the cutting element 16—for example, beyond the end of the slot 26′.

It should be understood that the slots may have a variety of shapes. Opposing sides of each slot (defined by neighboring teeth) may be parallel or may define a tapering width. The width of each slot (for example, measured parallel to the main axis) may be substantially constant over at least a portion of the length of the slot. Alternatively, the width may taper so that the open end of the slot is wider than the opposing, closed end of the slot. (This shape may be preferable, to facilitate the introduction of hairs into the open end of the slot.) Alternatively, in some examples, the width may taper so that the open end of the slot is narrower than the opposing, closed end of the slot.

More generally, the present disclosure relates, in part, to the hair-guiding element 10 as such, since the hair-guiding element 10 can in principle be supplied separately from any other component, such as the cutting element 16.

It is further contemplated that the hair-guiding element 10 is provided together with the cutting element 16 in the hair-cutting assembly 10, 16.

The present disclosure further provides an electric shaver comprising the hair-cutting assembly 10, 16 according to any of the embodiments described herein, and a motorized drive system for moving the cutting element 16.

In some embodiments, the hair-cutting assembly 10, 16 is arranged, in a shaver head of the electric shaver, adjacent to at least one further hair-cutting assembly.

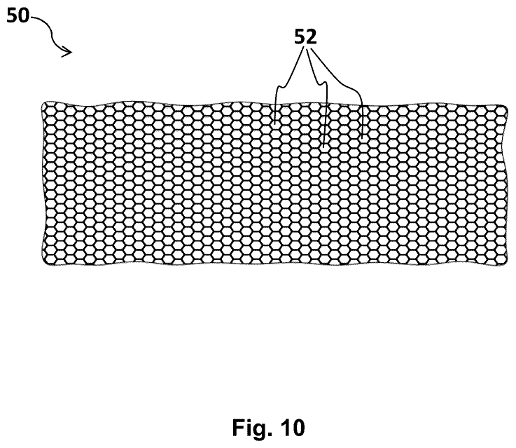

For example, the hair-cutting assembly 10, 16 is arranged, in the shaver head of the electric shaver, adjacent to at least one further hair-cutting assembly comprising a perforate foil 50, for instance of the type shown in FIG. 10, and an undercutter arranged to cut hair HA that protrudes through openings 52 of the perforate foil 50.

Such a perforate foil-undercutter arrangement of the further hair-cutting assembly can assist to cut shorter hairs HA while the hair-cutting assembly 10, 16 (that comprises the hair-guiding element 10 and the cutting element 16) may be for cutting longer hairs HA.

It is noted that the perforate foil 50 may be statically mounted in the shaver head, such that the perforate foil 50 is not itself driven by the motorized drive system. Rather, the undercutter may be driven by the motorized drive system so that the undercutter moves relative to the statically mounted perforate foil 50, so as to cut the hair HA that protrudes through the openings 52 of the perforate foil 50.

In some embodiments, the hair-cutting assembly 10, 16 is arranged in the shaver head in-between a first further hair-cutting assembly and a second further hair-cutting assembly.

In such embodiments, the first further hair-cutting assembly may comprise a first perforate foil 50 and a first undercutter arranged to cut hair HA that protrudes through first openings 52 of the first perforate foil 50, with the second further hair-cutting assembly comprising a second perforate foil 50 and a second undercutter arranged to cut hair HA that protrudes through second openings 52 of the second perforate foil 50.

The perforate foil 50 can be formed of any suitable material. In some embodiments, the perforate foil comprises a metallic material, such as stainless steel.

Components of the hair-cutting assembly 10, 16 and/or the further hair-cutting assembly(ies), such as the hair-guiding element 10, the cutting element 16 and/or the perforate foil 50 can be fabricated via a process that comprises etching a metallic substrate, such as a stainless steel substrate. Such processes are explained in detail below.

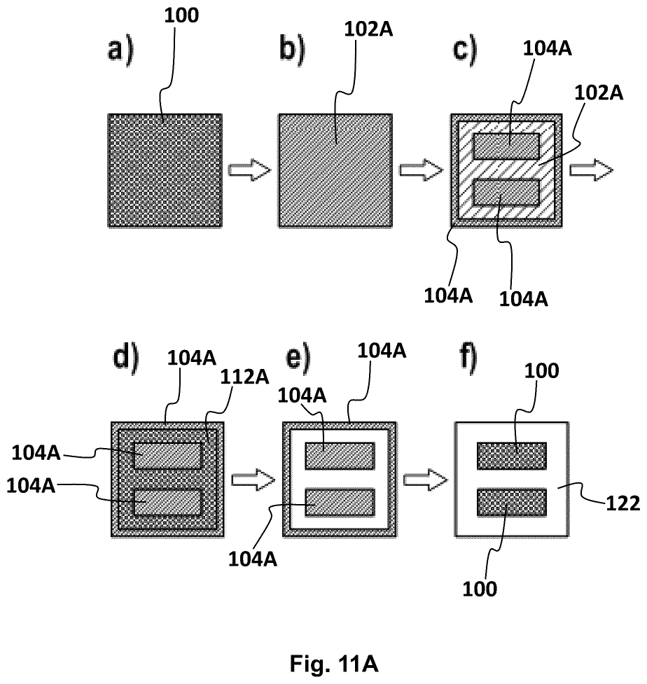

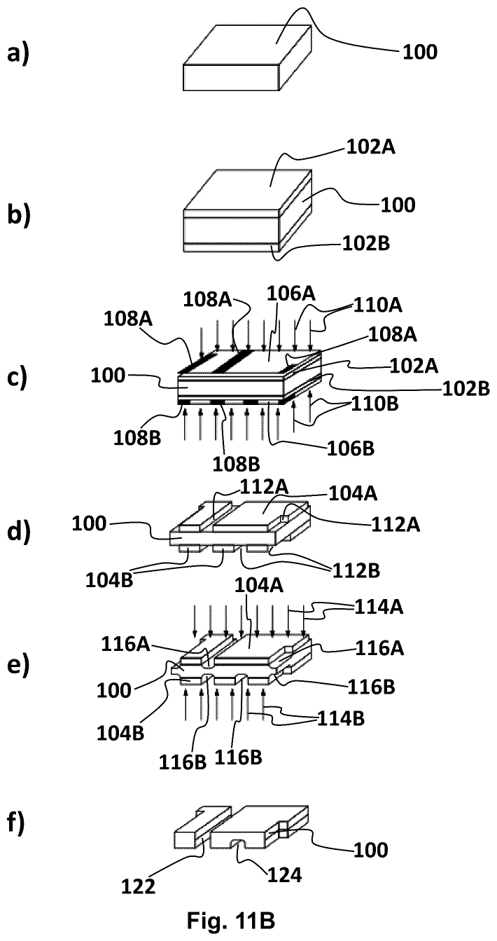

FIGS. 11A and 11B schematically depict such a metallic substrate 100 (see a) in FIG. 11A and a) in FIG. 11B), for example a stainless steel substrate, whose surface(s) may be treated, for instance cleaned, before photoresist layer(s) 102A, 102B is/are arranged thereon (see b) in FIG. 11A and b) in FIG. 11B). The arranging of the photoresist layer(s) 102A, 102B on the metallic substrate 100 may comprise applying a pre-formed photoresist film, which can, for example, be regarded as a dry photoresist film, to the metallic substrate 100. Alternatively or additionally, the arranging of the photoresist layer 102A, 102B on the metallic substrate 100 can comprise applying a lacquer to the metallic substrate 100, which lacquer dries to form the photoresist layer(s) 102A, 102B.

In the case of the pre-formed photoresist film, this may be applied to the metallic substrate 100 by rolling, for example hot-rolling, the pre-formed photoresist film onto the metallic substrate 100.

It is noted that the metallic substrate 100 may be a metallic sheet, in other words a sheet of metallic material, for instance a sheet of stainless steel.

In some embodiments, and referring to FIG. 11B, arranging the photoresist layer(s) 102A, 102B on the metallic substrate 100 comprises arranging a first photoresist layer 102A on a first side of the metallic substrate 100 and arranging a second photoresist layer 102B on a second side of the metallic substrate 100, which second side faces away from the first side.

Etch-resistant material 104A, 104B may be formed by selectively illuminating the photoresist layer(s) 102A, 102B arranged on the metallic substrate 100 (see c) in FIG. 11A and c) and d) in FIG. 11B).

In some embodiments, and referring to FIG. 11A, a pattern may be printed onto the photoresist layer 102A, 102B with a direct imager, where within the illuminated area(s) the photoresist layer(s) 102A, 102B is/are polymerized and thus fully adhered onto the surface(s) of the metallic substrate 100.

FIG. 11B shows a photo tool, for example photomask, having optically transmissive region(s) 106A, 106B, that allow(s) light 110A, 110B to reach the photoresist layer(s) 102A, 102B and polymerize the photoresist layer(s) 102A, 102B to form the etch-resistant material 104A, 104B, and optically opaque region(s) 108A, 108B that block the light 110A, 110B from reaching the photoresist layer(s) 102A, 102B, so as to leave the photoresist layer 102A, 102B there beneath unpolymerized.

The photoresist layer(s) 102A, 102B may be removed, in a subsequent development step, where the etch-resistant material 104A, 104B has not been formed by illumination of the photoresist layer(s) 102A, 102B (see d) in FIG. 11A and d) in FIG. 11B). For example, a solvent in which the photoresist layer(s) is/are soluble but in which the etch-resistant material 104A, 104B is insoluble may be applied to remove, in other words wash off, the photoresist layer(s) 102A, 102B where the etch-resistant material 104A, 104B has not been formed by illumination of the photoresist layer(s) 102A, 102B. Thus after development, masked region(s) of the metallic substrate 100 is/are provided in which the surface(s) of the metallic substrate 100 is/are masked by the etch-resistant material 104A, 104B, and non-masked region(s) 112A, 112B is/are provided where the etch-resistant material 104A, 104B is not masking the metallic substrate 100.

During etching, an etchant 114A, 114B is delivered to the metallic substrate 100 on which the etch-resistant material 104A, 104B is arranged (see e) in FIG. 11A and e) in FIG. 11B). The etch-resistant material 104A, 104B is resistant to the etchant 114A, 114B such that the etch-resistant material 104A, 104B protects subjacent region(s) of the metallic substrate 100 from being etched by the etchant 114A, 114B. Meanwhile, etched region(s) 116A, 116B, in which metallic material of the metallic substrate 100 is etched away by the etchant 114A, 114B, form beneath the non-masked region(s) 112A, 112B.

The etchant 114A, 114B can be delivered to the first side and/or to the second side of the metallic substrate 100 (on which the etch-resistant material 104A, 104B is arranged).

The etching may comprise spraying the metallic substrate 100, with the etch-resistant material 104A, 104B arranged thereon, with the etchant 114A, 114B, for example spraying the first side and/or the second side of the metallic substrate 100 with the etchant 114A, 114B.

Alternatively or additionally, the etching may comprise moving the metallic substrate 100, with the etch-resistant material 104A, 104B arranged thereon, through an etching zone in which the etchant 114A, 114B is delivered to, for instance sprayed onto, the metallic substrate 100.

In such embodiments, the etching can be controlled by, for example, controlling a speed with which the metallic substrate 100 is moved through the etching zone and/or adjusting dispensing parameter(s) that determine, for instance, how much etchant 114A, 114B is dispensed per unit time. Such dispensing parameter(s) can include, for instance, a delivery pressure of the etchant 114A, 114B.

Any suitable etchant 114A, 114B can be used provided that the etchant 114A, 114B is capable of etching the metallic material constituting the metallic substrate 100, for example stainless steel. In some embodiments, the etchant 114A, 114B comprises at least one selected from a ferric chloride solution, a copper sulfate solution, a nitric acid solution, and a picric acid solution. Such etchants may be particularly effective when, for instance, the metallic substrate 100 is a stainless steel substrate.

Following the etching, the etch-resistant material 104A, 104B may be removed to leave an etched metallic substrate 100. For example, the (polymerized) photoresist layer(s) 102A, 102B may be removed, and residues thereof stripped off, to afford a clean, all-metal surface of the etched metallic substrate 100 (see f) in FIG. 11A and f) in FIG. 11B).

In embodiments in which such an etching process is used in fabrication of component(s) of the hair-cutting assembly 10, 16 and/or the further hair-cutting assembly(ies), the etching resulting from delivery of the etchant 114A, 114B to the metallic substrate 100 (on which the etch-resistant material 104A, 104B is arranged) may define, at least in part, a geometry of the component(s), for example may define cutting edge(s) included in the component(s).

Such component(s) fabricated in this manner may have a defined overall geometry, for example including overall dimensions and edge geometry, for instance cutting edge geometry.

It is noted that the edge geometry, for example cutting edge geometry, may be generated by a combination of the etching process and the pattern of the etch-resistant material 104A, 104B, which may lead to a defined edge angle and, considering adhesion quality of the etch-resistant material 104A, 104B on the surface(s) of the metallic substrate 100, a defined radius (or defined radii) of curvature.

By controlling the etching process and the pattern of the etch-resistant material 104A, 104B, including its adhesion to the metallic substrate 100, the radii of curvature R1, R2 and/or R3 described above can be realized.

For example, one approach may be to use a metallic substrate 100 with equally patterned etch-resistant material 104A, 104B on each of the first and second sides of the metallic substrate 100, and to spray-etch towards both sides of the metallic substrate 100.

This may result in a defined edge angle, for example cutting edge angle, and a defined radius of curvature.

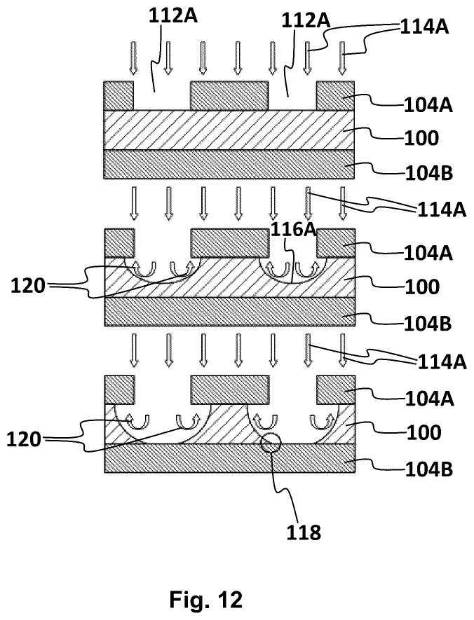

FIG. 12 schematically depicts profile development during a one-sided etching process of a metallic substrate 100 in the form of a metallic sheet. In this non-limiting example, a defined cutting edge geometry (see the circle 118 in FIG. 12) is provided on a side of the etched metallic substrate 100 that is opposite to the side of the metallic substrate 100 towards which the etchant 114A is delivered, for example sprayed.

Initially formed etched region(s) 116A in which metallic material of the metallic substrate 100 is etched away by the etchant 114A form beneath the non-masked region(s) 112A, and there may also be some under-etching beneath portion(s) of the etch-resistant material 114A disposed between the non-masked region(s) 112A, as denoted in FIG. 12 by the arrows 120.

In the scenario shown in FIG. 12, the metallic material of the metallic substrate 100 is ultimately completely removed by the etchant 114A beneath the non-masked region(s) 112A, so as to provide the defined cutting edge geometry 118 adjacent to where the metallic material is completely removed.

It is noted more generally, with reference to f) in FIG. 11A and f) in FIG. 11B, that the etching may remove all of the metallic material of the metallic substrate 100 beneath the non-masked region(s) 112A, 112B (see regions 122 in FIGS. 11A and 11B) and/or may only partially remove the metallic material of the metallic substrate 100 so as to reduce a thickness of the metallic substrate 100, without entirely removing the metallic material beneath the non-masked region(s) 112A, 112B (see the partially etched region(s) 124 in FIG. 11B).

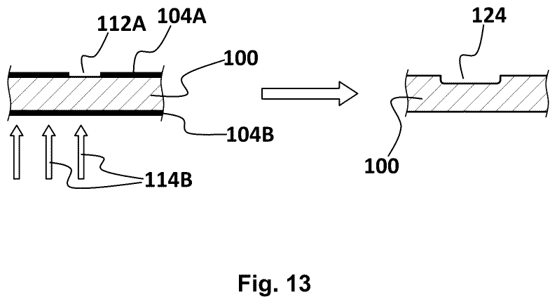

Regarding the partially etched region(s) 124 in which the thickness of the metallic substrate 100 is reduced, rather than the metallic material being removed entirely, one possibility for attaining such partially etched region(s) 124 may be to arrange a first etch-resistant material 104A on the first side of the metallic substrate 100, and a second etch-resistant material 104B on the second side of the metallic substrate 100. As shown in FIG. 13, non-masked region(s) 112A may expose some of the first side of the metallic substrate 100, but with the second etch-resistant material 104B forming a closed resist on the second side of the metallic substrate 100. In such an example, removal of less than half the metallic material can be achieved by delivering the etchant 114B only in the direction of the second side having the closed resist, and relying on an atmosphere of the etchant to partially remove the metallic material via contact with the first side of the metallic substrate 100 at which the non-masked region(s) 112A is/are provided. However, achieving such a partially etched region 124 in this manner may not permit simultaneous complete removal of the metallic material of an adjacent region of the metallic substrate 100.

It would accordingly be desirable to provide an etching method capable of providing a partially etched region 124 in a more controlled manner, for example in a way that enables the partially etched region 124 to be provided while there is complete removal of the metallic material at a region of the metallic substrate 100 adjacent to the partially etched region 124.

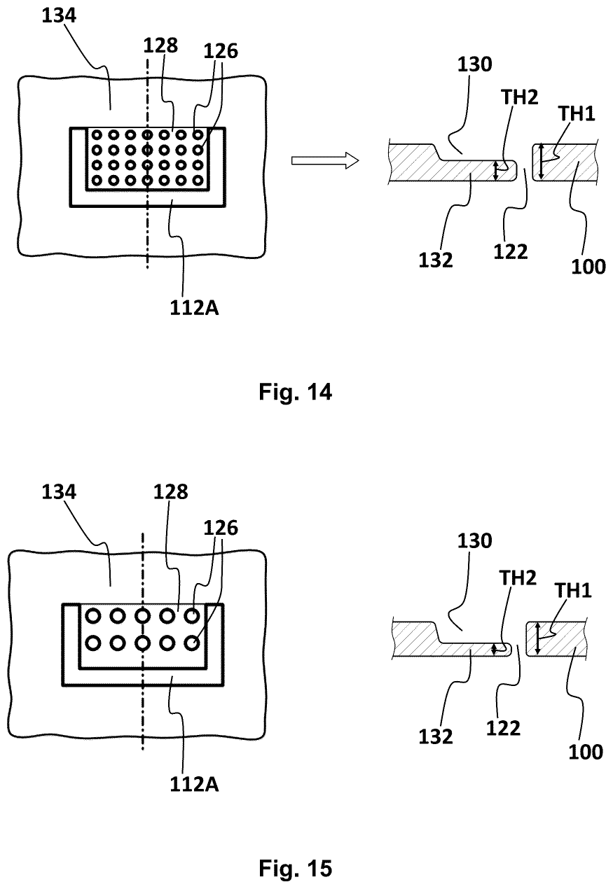

Referring now to FIG. 14, an etching method according to the present disclosure comprises providing the metallic substrate 100 on which the etch-resistant material 104A, 104B is arranged to mask the metallic substrate 100, through which etch-resistant material 104A, 104B apertures 126 are defined. The etch-resistant material 104A, 104B comprises a continuous region 128 that extends continuously between and surrounds the apertures 126.

The apertures 126 are thus separated from each other by the continuous region 128, such that the apertures 126 are not connected to each other.

The etching method includes etching the metallic substrate 100, with the etching including delivering the etchant 114A, 114B to the metallic substrate 100 through the apertures 126 so that discrete recessed regions in the metallic substrate 100 are initially etched beneath the apertures 126. This is in a manner akin to the initial formation of the etched regions 116A shown in FIG. 12, albeit noting that the discrete recessed regions form beneath the apertures 126 defined in the continuous region 128 of the etch-resistant material 104A, 104B rather than beneath the non-masked regions 112A. The etching is continued until at least some of the discrete recessed regions merge beneath the continuous region 128 of the etch-resistant material 104A, 104B so that the continuous region 128 extends over a location of the metallic substrate 100 located in-between the initially formed discrete recessed regions, at which location metallic material of the metallic substrate 100 is removed when the discrete recessed regions merge to form one or more merged etched regions 130. The etching leaves behind a portion 132 of the metallic substrate 100, which portion 132 of the metallic substrate 100 still remains beneath the one or more merged etched regions 130.

The apertures 126 provide a way of controlling dosing of the etchant 114A, 114B to the metallic substrate 100 so that the portion 132 of the metallic substrate 100 remains beneath the merged etched region(s) 130 after the etching.

Creating the portion 132 in this manner can, for example, be included in forming of the hair-guiding surface 18 of the hair-guiding element 10.

Each of the apertures 126 may have a diameter, or if not circular a largest dimension across the respective aperture 126, in the range of 5 μm to 500 μm. Alternatively or additionally, spacing between nearest neighbor apertures 126 may be in the range of 5 μm to 500 μm.

It is noted that the apertures 126 can, for example, be regarded as microapertures, for example microapertures whose diameter or largest dimension (if not circular) is in the range of 5 μm to 500 μm.

For the avoidance of any doubt, the diameter or largest dimension refers to measurement of the respective aperture 126 when the metallic substrate 100 is viewed in plan, facing the continuous region 128 (as shown on the left hand side of each of FIGS. 14 to 16).

In some embodiments, an open area of the continuous region 128 is 25% or less, for example is in the range of 0.01% to 25%, such as 1% to 25%, with the open area being determined by (i) obtaining a fraction by dividing a total area of the apertures 126 by a total area of the etch-resistant material 104A, 104B in which the continuous region 128 and the apertures 126 are provided, and (ii) multiplying the fraction by 100.

Such a maximum 25% open area can help to minimize the risk of over-etching of the metallic substrate 100.

For illustration, a resolution limit of an illuminator for selectively illuminating the photoresist layer(s) 102A, 102B may be 20 μm to 25 μm, giving an area per aperture 126 (which is circular in this non-limiting example) of 314 μm² to 525 μm². An open area of 25% corresponds to a ratio of an area covered by the continuous region 128 to an uncovered area corresponding to the apertures of 3:1. Hence for an area per aperture 126 of 314 μm² to 525 μm², a minimum total area of the etch-resistant material 104A, 104B per aperture 126 would be 1256 μm² to 2100 μm².

It is noted that the area of the continuous region 128 used for the open area determination may be delimited by a notional boundary corresponding to the shortest line that can be drawn around outermost apertures 126 of the apertures 126, with the line meeting the perimeter of each of the outermost apertures 126.

The apertures 126 can, for instance, be provided by the photoresist layer(s) 102A, 102B being selectively illuminated, for example via use of a photomask, so that the photoresist layer(s) 102A, 102B is/are not illuminated at points where the apertures 126 are to be provided. Hence during development, the photoresist layer(s) 102A, 102B may be removed at these points, thereby providing the apertures 126.

Once the apertures 126 are defined through the etch-resistant material 104A, 104B, the delivery of the etchant 114A, 114B through the apertures 126 causes formation of the merged etched region(s) 130 with the portion 132 of the metallic substrate 100 still remaining beneath the merged etched region(s) 130 following the etching.

Regarding delivery of the etchant 114A, 114B, if it is desired to keep the dispensing parameter(s), such as the delivery pressure, constant, the speed with which the metallic substrate 100 is moved through the etching zone can be increased if the metallic substrate 100 is etched more than desired, for example unintentionally etched completely through the metallic substrate 100 beneath the apertures 126. On the other hand, the speed with which the metallic substrate 100 is moved through the etching zone can be decreased if a greater degree of etching is needed in order to provide the merged etched region(s) 130.

If it is desired to keep constant the speed with which the metallic substrate 100 is moved through the etching zone, the dispensing parameter(s) can be adjusted to provide the merged etched region(s) 130 with the portion 132 of the metallic substrate 100 still remaining beneath the merged etched region(s) 130. For example, the delivery pressure of the etchant can be decreased if the metallic substrate 100 is etched more than desired, for example unintentionally etched completely through the metallic substrate 100 beneath the apertures 126. On the other hand, the delivery pressure can be increased if a greater degree of etching is needed in order to provide the merged etched region(s) 130.

If it is desired to keep existing dispensing parameter(s), for example delivery pressure, constant and also to retain an existing speed of the metallic substrate 100 through the etching zone, the apertures 126, such as their diameter(s) or largest dimension(s) (for example within the range of 5 μm to 500 μm), spacing (for example within the range of 5 μm to 500 μm) and/or number, can be adjusted to provide the merged etched region(s) 130 with the portion 132 of the metallic substrate 100 still remaining beneath the merged etched region(s) 130. For example, the diameter(s)/largest dimension(s) of the apertures 126 can be decreased if the metallic substrate 100 is etched more than desired, for example unintentionally etched completely through the metallic substrate 100. On the other hand, the diameter(s)/largest dimension(s) of the apertures 126 can be increased if a greater degree of etching is needed in order to provide the merged etched region(s) 130.

This may represent a benefit of the etching method according to the present disclosure, since adjusting the size, spacing and/or number of aperture(s) 126 can provide a way of realizing an etched metallic substrate 100 having a three-dimensional shape associated with the portion 132 but without having to adjust existing process settings.

Referring to FIGS. 14 to 16, the metallic substrate 100, for example metal sheet, may have a first thickness TH1 prior to the etching. The first thickness TH1 may be, for example, 0.04 mm to 2.5 mm.

The etching may be continued until the metallic substrate's thickness is reduced so that the metallic substrate 100 has one or more second thicknesses TH2; TH2A, TH2B beneath the one or more merged etched regions 130, and with the one or more second thicknesses TH2; TH2A, TH2B being non-zero but smaller than the first thickness TH1, for example smaller than the first thickness TH1 of 0.04 mm to 2.5 mm.

In some embodiments, the etching is continued until the portion 132 beneath the one or more merged etched regions 130 comprises a planar region of the etched metallic substrate 100, which planar region is disposed beneath at least some of the apertures 126 and beneath where the continuous region 128 of the etch-resistant material 104A, 104B extends between the at least some of the apertures 126.

FIGS. 14 and 15 schematically show how the size of the apertures 126 can influence how much of the portion 132 remains following the etching. In FIG. 15, larger apertures 126 cause more removal of the metallic substrate 100, so as to provide a thinner portion 132, compared to the portion 132 provided due to the smaller apertures 126 shown in FIG. 14. This may be due to more etchant 114A, 114B being able to reach areas of the metallic substrate 100 beneath the larger apertures 126 shown in FIG. 15 compared to the amount of etchant being able to reach areas of the metallic substrate 100 beneath the smaller apertures 126 shown in FIG. 14.

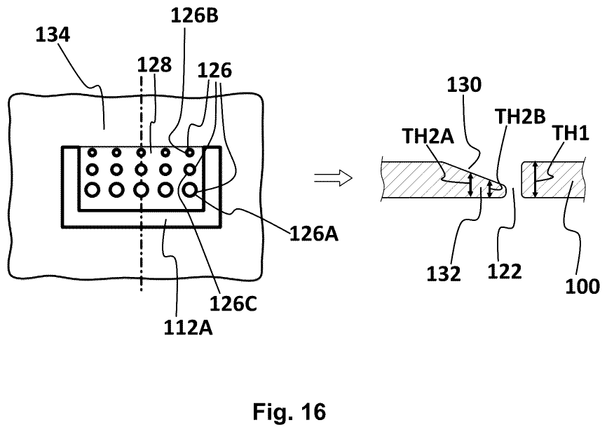

In some embodiments, such as shown in FIG. 16, the apertures 126 through the self-same continuous region 128 include larger apertures 126A and smaller apertures 126B, with the larger aperture(s) 126A allowing more of the etchant 114A, 114B to pass therethrough to reach the metallic substrate 100 than the smaller aperture(s) 126B during the etching.

In such embodiments, the larger aperture(s) 126A and smaller aperture(s) 126B may, for example, be arranged relative to each other so that the etching provides a ramped profile, for example a ramped planar region, that inclines from a lower region of the etched metallic substrate 100 where more of the metallic substrate 100 is removed beneath the larger aperture(s) 126A to an upper region of the etched metallic substrate 100 where less of the metallic substrate 100 is removed beneath the smaller aperture(s) 126B.

Such a ramped profile can, for example, be achieved by the apertures' 126 size progressively changing, for instance so that intermediately sized aperture(s) 126C, whose size is between that of the larger apertures 126A and the smaller apertures 126B, is/are arranged between the larger aperture(s) 126A and the smaller aperture(s) 126B.

It is noted that implicit to the ramped profile is that the etched metallic substrate 100 has multiple second thicknesses TH2A, TH2B, of which only two are denoted by double-headed arrows in FIG. 16.

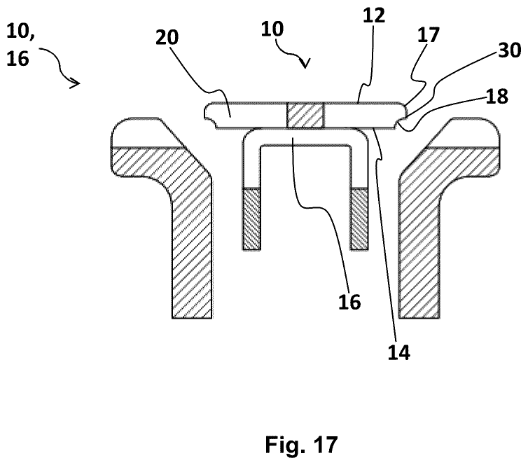

Referring to FIG. 17, the provision of the ramped profile, via the larger aperture(s) 126A and the smaller aperture(s) 126B, can be included in forming of the sloping surface of the hair-guiding element's 10 hair-guiding surface 18. Moreover, the size of the apertures 126, in particular the larger aperture(s) 126A in the case of forming the sloping surface, can assist to control the etching so that a desired tooth thickness T1 is attained at the tip region 30.

It is noted that the etching method according to the present disclosure may enable ramped profiles, for example chamfer geometries, in which a length of the ramped profile is longer than half the metallic substrate's 100 thickness TH1. Thus, the sloping surface whose lateral extent L1 is greater, for example at least two times greater, that its height H1 can, for example, be attained using the etching method. It is reiterated that the lateral extent L1 may be, for example at least 200 μm while the height H1 may be 100 μm or less.

In some embodiments, and referring again to FIGS. 14 to 16, one or more non-masked regions 112A, 112B is/are provided adjacent to where the etch-resistant material 104A, 104B is masking the metallic substrate 100, with the etching being continued until the metallic substrate 100 is entirely removed by the etching beneath the one or more non-masked regions 112A, 112B but with the portion 132 of the metallic substrate 100 still remaining beneath the one or more merged etched regions 130.

Thus, a single etching step can be used to etch the metallic substrate 100 entirely through its thickness beneath the non-masked regions 112A, 112B, but only partially etch the metallic substrate 100 at the merged etched region(s) 130.

This single etching step can mean that, for instance, the etch-resistant material 104A, 104B can be arranged on (as yet) unetched surface(s) of the metallic substrate 100, for example metallic sheet. For instance, the etch-resistant material 104A, 104B may be arranged on surface(s) of the metallic substrate 100, for example metallic sheet, that have been surface-treated, for instance cleaned, but not etched by a previous etching process.

Alternatively or additionally, the etching method may further comprise, following the etching, removing the etch-resistant material 104A, 104B to leave an etched metallic substrate 100 comprising the one or more merged etched regions 130 with the portion 132 of the metallic substrate 100 still remaining beneath the one or more merged etched regions 130.

Still referring to FIGS. 14 to 16, the continuous region 128 of the etch-resistant material 104A, 104B may be connected to a peripheral region 134 of the etch-resistant material 104A, 104B, with the continuous region 128 remaining connected to the peripheral region 134 following the etching to form the one or more merged etched regions 130. The peripheral region 134 may, for example, be devoid of apertures.

The peripheral region 134 can assist to retain the continuous region 128 in place during the etching, so as to reduce the risk of the continuous region 128 being removed during the etching and concomitant unintentional over-etching of the metallic substrate 100.

When the metallic substrate 100 is viewed in plan, facing the continuous region 128 of the etch-resistant material 104A, 104B, the continuous region 128 may be in the form of a tongue-like protrusion that protrudes relative to the peripheral region 134.

Since the etchant 114A, 114B is delivered through the apertures 126, the delivery direction along which the etchant 114A, 114B is delivered, for example sprayed, may be towards the side of the metallic substrate 100 on which the continuous region 128 of the etch-resistant material 104A, 104B is arranged.

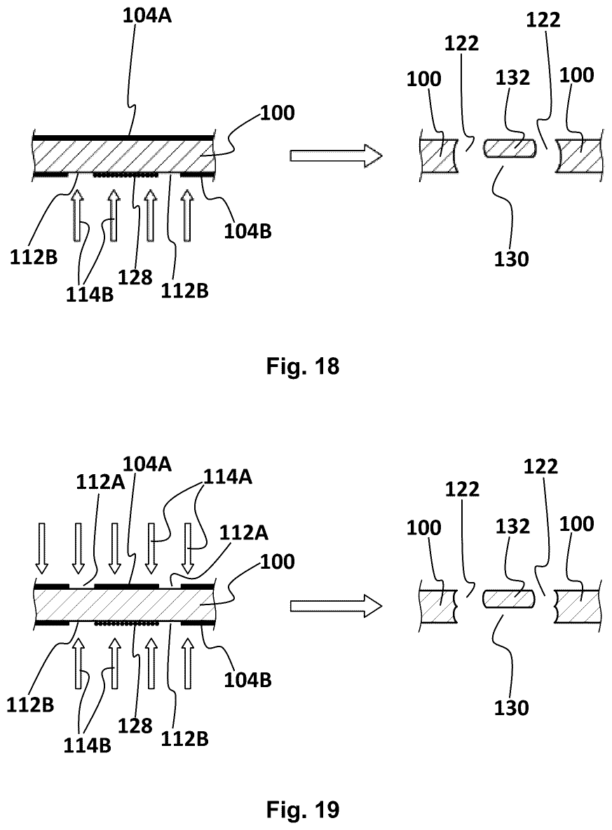

The etchant 114B may be delivered towards only one side of the metallic substrate 100, as shown in FIG. 18, or the etchant 114A, 114B may be delivered towards both sides of the metallic substrate 100, as shown in FIG. 19.

The capability to equally spray-etch from both sides of the metallic substrate 100, for example metallic sheet, can provide, for instance, a desired cutting edge geometry, but can still form the three-dimensional shape associated with the portion 132 of the metallic substrate 100 that remains following the etching.

When the etchant 114B is delivered towards only one side of the metallic substrate 100, the continuous region 128 (delimiting the apertures 126) may be arranged on the side of the metallic substrate 100 towards which the etchant 114B is being delivered.

In such embodiments, the etch-resistant material 104A, 104B may nonetheless include the (first) etch-resistant material 104A arranged on the side of the metallic substrate 100 that faces away from the single side of the metallic substrate 100 towards which the etchant 114B is being directed.

A benefit of only delivering, for instance spraying, the etchant 114A, 114B to one of the sides of the metallic substrate 100 in this manner may be that a different radius of curvature (and cutting angle when a blade is being manufactured) can be obtained compared to when the etchant 114A, 114B is delivered to both sides of the metallic substrate 100.

In more general terms, in embodiments in which the etch-resistant material 104A, 104B comprises the first etch-resistant material 104A arranged to mask the first side of the metallic substrate 100, and the second etch-resistant material 104B arranged to mask the second side of the metallic substrate 100, with the second side facing away from the first side, the first etch-resistant material 104A may include the continuous region 128 that surrounds and extends between the apertures 126, and the second etch-resistant material 104B may include a further continuous region through which further apertures are defined.

The further continuous region may, for example, surround and extend between the further apertures.

In embodiments in which the continuous region 128 and the further continuous region are employed, such as shown in FIG. 19, part of the metallic substrate 100 in which the one or more merged etched regions 130 is/are formed is, following the etching, sandwiched in-between the continuous region 128 and the further continuous region.

In some embodiments, such as shown in FIG. 19, one or more non-masked regions 112A is/are provided adjacent to where the first etch-resistant material 104A is arranged to mask the first side of the metallic substrate 100, and/or one or more (further) non-masked regions 112B is/are provided adjacent to where the second etch-resistant material 104B is arranged to mask the second side of the metallic substrate 100.

For example, at least one of the one or more (further) non-masked regions 112B is aligned with one of the one or more non-masked regions 112A.

This can assist etching of the metallic substrate 100 entirely through its thickness between the aligned non-masked region(s) 112A and (further) non-masked region(s) 112B.

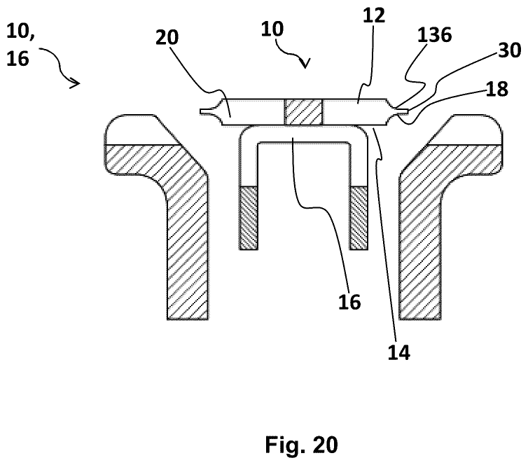

Referring now to FIG. 20, the continuous region 128 through which the apertures 126 are defined can enable forming of the hair-guiding element 10 comprising the hair-guiding surface 18 and the tip region 30 as previously described, while the further continuous region through which the further apertures are defined can enable forming of a recessed portion 136 of the skin-contacting surface 12 of the hair-guiding element 10.

At least some of the apertures 126 may be arranged in an ordered pattern, as in the case of the embodiments shown in FIGS. 14 to 16, 21, 22 and 24. Alternatively or additionally, at least some of the apertures 126 may be distributed in an irregular manner, as in the case of the embodiment shown in FIG. 23.

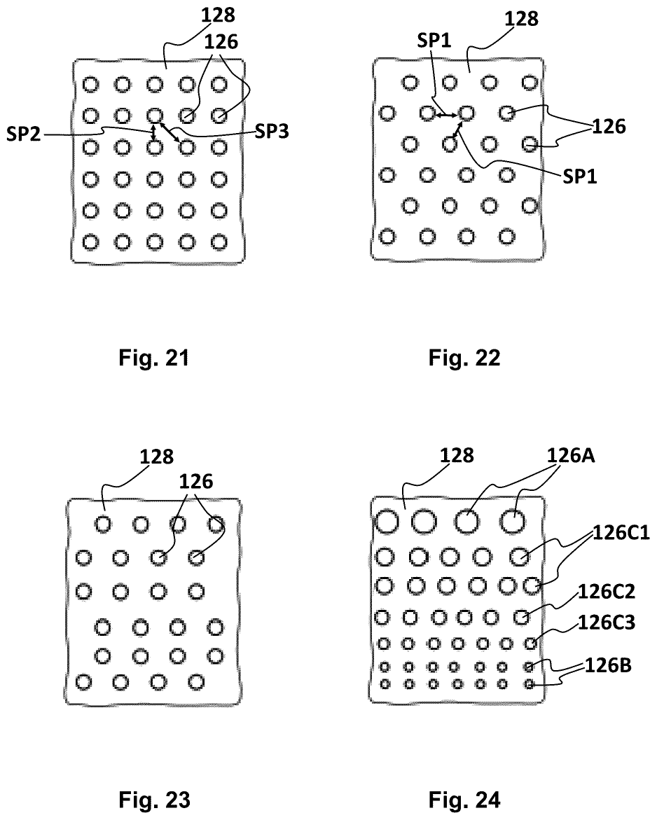

In some embodiments, the ordered pattern comprises an array of apertures 126. The ordered pattern may comprise, for example, at least one of a rectangular array of apertures 126 (see FIG. 21) and a hexagonal array of apertures (see FIG. 22).

In the hexagonal array, and referring to FIG. 22, each aperture 126 is spaced by a single distance SP1 from its six nearest neighboring apertures. The hexagonal array can accordingly help to provide relatively uniform etching in the merged etched region 130 beneath the hexagonal array of apertures 126.

By contrast, and referring to FIG. 21, in the rectangular array there may be a first, nearest neighbor distance SP2 between a given aperture 126 and four of eight apertures 126 that surround the given aperture 126 in the rectangular array, and a second distance SP3, greater than the first, nearest neighbor distance SP2, between the given aperture 126 and the other four of the eight apertures 126 that surround the given aperture 126 in the rectangular array.

It is noted that FIG. 24 shows an ordered array of apertures 126 whose size progressively changes, so that intermediately sized aperture(s) 126C1, 126C2, 126C3 are arranged between larger aperture(s) 126A and smaller aperture(s) 126B.

For example, the intermediately sized apertures 126C1, 126C2, 126C3 can comprise largest intermediately sized apertures 126C1, smallest intermediately sized apertures 126C3, and medium intermediately sized apertures 126C2 whose size is between that of the largest intermediately sized apertures 126C1 and the smallest intermediately sized apertures 126C3.

More generally, the present disclosure provides a method of manufacturing a foil 50, comb or blade 10, 16 for an electric shaver, with the method comprising implementing the etching method according to any of the embodiments described herein, to provide an etched article having the one or more merged etched regions 130 with the portion 132 of the metallic substrate 100 still remaining beneath the one or more merged etched regions 130. The etched article may define the foil 50, comb or blade 10, 16, or the foil 50, comb or blade 10, 16 may be formed by subjecting the etched article to one or more post-processes implemented subsequently to the etching.

It is noted that the term “blade” can in principle encompass the foil 50 and the hair-guiding element 10, e.g. comb, since the foil 50 and the hair-guiding element 10 can interact with the undercutter or cutting element 16 such that hair HA is cut between the foil 50/hair-guiding element 10 and the undercutter/cutting element 16. The term “blade” can also encompass the undercutter and the cutting element 16.

The one or more post-processes may, for example, include polishing of the etched article and/or subjecting the etched article to precision (or pulsed) electrochemical machining (PECM).

However, a benefit of the etching method described herein is that there may be no need for an additional process step, such as a PECM-comprising additional process step, to generate a three-dimensional shape in which metallic material of the metallic substrate 100 is only partially removed.

Regarding the perforate foil 50, the etching method described herein, and in particular the portion 132 remaining following the etching, can provide a three-dimensional geometry of the perforate foil 50 that is in addition to the perforate foil's 50 openings 52. The perforate foil 50 can, for example, be made of stainless steel and etched using the etching method described herein.

It is reiterated that the etching method described herein can generate a three-dimensional shape of the etched metallic substrate 100, due to the portion 132 that remains beneath the merged etched region(s) 130 following the etching, for example so that only one masking with the photoresist layer 102A, 102B, illumination and etching sequence is required, rather than a plurality of such sequences having to be implemented.

The three-dimensional shape can, for example, serve as friction reduction, generation of defined geometries for improvement of hair feeding, lifting, gliding, etc., in component(s) of an electric shaver, such as the hair-guiding element 10, for example comb, the cutting element 16 and/or the perforate foil 50.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention. Any reference signs in the claims should not be construed as limiting the scope.

What is claimed is:

1. A hair-guiding element for an electric shaver, the hair-guiding element comprising:
a skin-contacting surface for contacting skin;
a cutting element-facing surface for facing a cutting element, wherein the cutting element-facing surface faces in an opposite direction with respect to a direction faced by the skin-contacting surface;
a hair-guiding surface on which hair from the skin is receivable, so as to be guided on the hair-guiding surface, when the skin-contacting surface is in contact with the skin; and
a toothed profile comprising teeth arranged along a main axis of the hair-guiding element, with the teeth each comprising part of the skin-contacting surface and part of the cutting element-facing surface,
wherein at least some of the teeth each comprise a part of the hair-guiding surface and a tip region that is arranged to receive the hair thereon when the hair-guiding element is moved over the skin, with the part of the hair-guiding surface extending, in a direction transverse to the main axis, away from the tip region and towards the part of the cutting element-facing surface so as to enable the part of the hair-guiding surface to guide the hair that has been received on the tip region towards the part of the cutting element-facing surface, and
wherein a tooth thickness at the tip region is less than about 250μm, which tooth thickness is a diameter of a smallest notional circle whose circumference is intersected by both the part of the hair-guiding surface and the part of the skin-contacting surface, with the smallest notional circle's plane being perpendicular to the main axis.

2. The hair-guiding element according to claim 1, wherein the part of the hair-guiding surface of the at least some of the teeth comprises a sloping surface that declines, as the sloping surface extends transverse to the main axis from the tip region towards the part of the cutting element-facing surface, with the sloping surface becoming further from the skin-contacting surface as the sloping surface declines towards the part of the cutting element-facing surface.

3. The hair-guiding element according to claim 2, wherein a step is defined between a lowermost region of the declining sloping surface and the part of the cutting element-facing surface, wherein the step provides a height difference between the part of the cutting element-facing surface and the lowermost region of no more than about 50μm.

4. The hair-guiding element according to claim 3, wherein the sloping surface has a gradient defined by a lateral extent of the sloping surface being greater than a height of the sloping surface, with the lateral extent extending, parallel with the skin-contacting surface, from the tip region to a first point aligned with the lowermost region of the sloping surface at a base of the step, and with the height extending, normal to the skin-contacting surface, from the tip region to a second point aligned with the lowermost region; optionally wherein the lateral extent is at least two times greater than the height.

5. The hair-guiding element according to claim 2, wherein a lowermost region of the sloping surface is where the sloping surface reaches, in a stepless manner, the cutting element-facing surface.

6. The hair-guiding element according to claim 5, wherein the sloping surface has a gradient defined by a lateral extent of the sloping surface being greater than a height of the sloping surface, with the lateral extent extending, parallel with the skin-contacting surface, from the tip region to a first point aligned with the lowermost region of the sloping surface, and with the height extending, normal to the skin-contacting surface, from the tip region to a second point aligned with the lowermost region; optionally wherein the lateral extent is at least two times greater than the height.

7. The hair-guiding element according to claim 1, wherein the teeth comprise a first set of teeth that extend, transverse to the main axis of the hair-guiding element, in a first direction, and a second set of teeth that extend, transverse to the main axis of the hair-guiding element, in a second direction opposite to the first direction.

8. The hair-guiding element according to claim 7, wherein slots separate neighboring teeth from each other along the main axis of the hair-guiding element, with the slots comprising pairs of slots, wherein each of the pairs of slots comprises a longer slot and a shorter slot, wherein the longer slot and the shorter slot of each pair extend along a common slot axis that is transverse to the main axis, with one of the longer slot and the shorter slot being defined between neighboring teeth of the first set of teeth, and the other of the longer slot and the shorter slot being defined between neighboring teeth of the second set of teeth.

9. The hair-guiding element according to claim 7, comprising a spinal portion, from which spinal portion the first set of teeth extend, transverse to the main axis, in the first direction, and from which spinal portion the second set of teeth extend, transverse to the main axis, in the second direction, wherein the spinal portion has a meandering shape that causes longer and shorter slots to alternate along the first set of teeth while shorter and longer slots alternate along the second set of teeth.

10. The hair-guiding element according to claim 1, wherein the skin-contacting surface is at least partly delimited by a rounded edge part that convexly curves towards the cutting element-facing surface.

11. The hair-guiding element according to claim 10, wherein the rounded edge part has a radius of curvature of at least about 30μm.

12. A hair-cutting assembly comprising:
the hair-guiding element according to claim 1; and
a cutting element arranged to face the cutting element-facing surface.

13. An electric shaver comprising:
the hair-cutting assembly according to claim 12; and
a motorized drive system for moving the cutting element.
